(19) United States
(12) Patent Application Publication
(10) Pub. No.: US 2011/0286502 A1
(43) Pub. Date: Nov. 24, 2011

(54) WIRELESS TRANSMITTER AND PRECODING METHOD

(75) Inventors: Fumiyuki Adachi, Miyagi (JP); Kazuki Takeda, Miyagi (JP); Shinsuke Takaoka, Kanagawa (JP); Kenichi Miyoshi, Kanagawa (JP); Megumi Ichikawa, Kanagawa (JP)

(73) Assignee: Panasonic Corporation, Osaka (JP)

(21) Appl. No.: 13/063,420

(22) PCT Filed: Sep. 11, 2009
(86) PCT No.: PCT/JP2009/004529

§ 371 Date: Jul. 25, 2011

(30) Foreign Application Priority Data
Sep. 12, 2008 (JP) 2008-234979

(51) Int. Cl. H04L 27/01; H04B 1/38

(52) U.S. Cl. 375/219; 375/232

(57) ABSTRACT

Disclosed is a wireless transmitter that can prevent deterioration of the error rate characteristic without reducing the data rate during mobile communications also utilizing THP for FDE. In the device, an equivalent channel matrix computation unit (118) computes weights to be used for FDE of a transmission block and an equivalent channel matrix indicating equivalent channels that are generated from channel impulse responses, and a decomposition unit (119) obtains a lower triangular matrix (L), that consists of a diagonal element that includes a high channel quality at the front of the transmitting block and a low channel quality at the rear, so as to indicate the channel quality of the transmission block, and an element indicating interference with the transmission block, and a unitary matrix (Q) by means of LQ decomposition of the equivalent channel matrix. A computation unit (120) uses the lower triangular matrix (L) and the average channel quality to compute a matrix (B) that minimizes the mean square error of all symbols between the transmission block before precoding and a block received by a wireless receiver. A preceding unit (103) performs THP of the transmission block using the matrix (B).

### TECHNICAL FIELD

The present invention relates to a radio transmitting apparatus and a precoding method.

### BACKGROUND ART

In recent years, modes of service have diversified in a radio communication system, typically represented by a mobile telephone system, and there is a demand to transmit, in addition to sound/voice data, a large volume of data such as still image data and moving image data, with high speed and high quality, through radio transmission.

It is well settled that, when high speed wireless transmission is performed in mobile communication, a communication channel will become a frequency selective fading channel that is comprised of a plurality of paths of varying delay times. Consequently, for example, in single-carrier (“SC”) transmission in mobile communication, inter-symbol interference (“ISI”) is produced, in which a preceding channel interferes with a subsequent channel, and the error rate performance is severely deteriorated (see, for example, non-patent literature 1).

Equalization technology refers to a technique of improving error rate performance by removing the influence of ISI. For example, frequency domain equalization (“FDE”) used in a radio receiving apparatus uses an equalization technology. In FDE, a received block is separated into orthogonal frequency components through the fast Fourier transform (“FFT”), and each frequency component is multiplied by an equalization weight (FDE weight) that is close to the reciprocal of the channel transfer function, and later converted into a time domain signal through the inverse fast Fourier transform (“IFFT”). By means of this FDE, it is possible to correct the spectrum distortion of a received block, and, as a result, reduce ISI and improve error rate performance.

Now, a mobile communication terminal apparatus such as a mobile telephone basically operates on a battery, so that the power consumption of a radio receiving apparatus to be mounted on that mobile communication terminal apparatus is preferably even lower. Furthermore, a mobile communication terminal apparatus such as a mobile telephone is preferably miniaturized, so that a radio receiving apparatus to be mounted on that mobile communication terminal apparatus is preferably miniaturized even smaller.

So, as a technique to realize a radio receiving apparatus that removes the influence of ISI and that is formed in a simple configuration, joint THP/transmission FDE to use Tomlinson-Harashima precoding (hereinafter “THP”), which is a precoding technology, and FDE, in combination, is studied (see, for example, non-patent literature 2). That is to say, study is underway to perform THP for a transmission block and perform FDE for the transmission block after THP in a radio transmitting apparatus. In THP, processing to sequentially subtract interference components of a transmission block based on channel information, is performed. By means of this THP, it is possible to cancel interference components added to a transmission block, in advance, reduce ISI and improve error rate performance. For example, even when there is a frequency component with its received level having so significantly lowered due to the influence of frequency selective fading that even FDE cannot completely equalize this frequency component and leaves an interference component (residual ISI), it is still possible to prevent error rate performance deterioration by canceling residual ISI in advance by using FDE and THP in combination. Furthermore, a radio transmitting apparatus performs the entire equalization processing, so that it is possible to realize a mobile communication terminal apparatus having a radio receiving apparatus that is smaller and that consumes less power than heretofore.

Also, a method to combine THP and received signal detection in a code division multiple access communication system is under study as a technique to realize a radio receiving apparatus that removes the influence of ISI and that is formed in a simple configuration (see, for example, patent literature 1).

When joint THP/transmission FDE is applied to SC transmission, although ISI is completely removed, channel quality (represented by, for example, the signal-to-noise power ratio (SNR)) becomes poor in symbols near the end of a transmission block after FDE, causing error rate performance deterioration. In order to prevent this deterioration of error rate performance, a conventional radio transmitting apparatus inserts a dummy symbol near the end of a transmission block where the SNR is poor (see, for example, non-patent literature 2).

### CITATION LIST

### Patent Literature

PTL 1
Japanese Patent Application Laid-Open No. 2007-060662

### Non-Patent Literature

NPL 1
W. C. Jakes Jr., Ed., Microwave mobile communications, Wiley, New York, 1974
NPL 2: RCS 2007-75, pp. 129-134 (K. Takeda, H. Tomeba, F. Adachi, “Joint THP/pre-FDE for Single-Carrier Transmission,” IEICE Technical Report, RCS 2007-75, pp. 129-134, 2007-8)

### SUMMARY OF INVENTION

### Technical Problem

When a dummy symbol is inserted near the end of a transmission block like in the conventional art described above, although error rate performance may improve, a data rate decrease to match the length of the dummy symbol is caused.

It is therefore an object of the present invention to provide a radio transmitting apparatus and a precoding method whereby error rate performance deterioration can be prevented without causing a decrease of data rate, in mobile communication in which FDE and precoding are used in combination.

### Solution to Problem

A radio transmitting apparatus according to the present invention employs a configuration having: an operating section that performs an operation of an equalization channel matrix representing an equalization channel formed with a weight to use in equalization processing of a transmission block and a channel impulse response; a decomposing section that acquires lower triangular matrix L and unitary matrix Q by performing LQ decomposition of the equalization channel matrix, lower triangular matrix L comprising diagonal elements representing channel quality of the transmission block including higher channel quality in a first half of the transmission block and lower channel quality in a second half of the transmission block, and elements representing interference of the transmission block; a calculating section that calculates matrix B that minimizes a total of mean square errors of all symbols, between the transmission block prior to precoding and a received block in a radio receiving apparatus, using lower triangular matrix L and average channel quality; a precoding section that performs Tomlinson-Harashima precoding of the transmission block using matrix B; and an equalizing section that performs equalization processing of the transmission block using the weight.

A precoding method according to the present invention includes: performing an operation of an equalization channel matrix representing an equalization channel formed with a weight to use in equalization processing of a transmission block and a channel impulse response; acquiring lower triangular matrix L and unitary matrix Q by performing LQ decomposition of the equalization channel matrix, lower triangular matrix L comprising diagonal elements representing channel quality of the transmission block including higher channel quality in a first half of the transmission block and lower channel quality in a second half of the transmission block, and elements representing interference of the transmission block; calculating matrix B that minimizes a total of mean square errors of all symbols, between the transmission block prior to precoding and a received block in a radio receiving apparatus, using lower triangular matrix L and average channel quality; and performing Tomlinson-Harashima precoding of the transmission block using matrix B.

### Advantageous Effects of Invention

With the present invention, it is possible to prevent error rate performance deterioration without causing a decrease of data rate in mobile communication in which FDE and precoding are used in combination.

### BRIEF DESCRIPTION OF DRAWINGS

FIG. 1 shows a simplified channel according to embodiment 1 of the present invention;

FIG. 2 shows input/output characteristics of modulo operation according to embodiment 1 of the present invention;

FIG. 3 shows diagonal elements of lower triangular matrix L according to embodiment 1 of the present invention;

FIG. 4 shows an error vector to be minimum according to an MMSE criterion, according to embodiment 1 of the present invention;

FIG. 5 shows error rate performance according to embodiment 1 of the present invention;

FIG. 6 is a block diagram showing a radio transmitting apparatus according to the present invention;

FIG. 7 is a block diagram showing an inner configuration of a precoding section according to embodiment 1 of the present invention;

FIG. 8 is a block diagram showing a radio receiving apparatus according to embodiment 1 of the present invention;

FIG. 9 is a block diagram showing another radio transmitting apparatus according to embodiment 1 of the present invention;

FIG. 10 shows diagonal elements of lower triangular matrix L and diagonal elements of matrix B according to embodiment 2 of the present invention;

FIG. 11 is a block diagram showing a radio transmitting apparatus according to embodiment 2 of the present invention;

FIG. 12 is a block diagram showing a radio receiving apparatus according to embodiment 3 of the present invention (reporting method 1);

FIG. 13 is a block diagram showing a radio transmitting apparatus according to embodiment 3 of the present invention (reporting method 1);

FIG. 14 illustrates a table showing associations between average SNRs and reporting intervals according to embodiment 3 of the present invention;

FIG. 15 is a block diagram showing a radio receiving apparatus according to embodiment 3 of the present invention (reporting method 2);

FIG. 16 is a block diagram showing a radio transmitting apparatus according to embodiment 3 of the present invention (reporting method 2); and

FIG. 17 illustrates a table showing associations between average SNRs and the numbers of reporting bits according to embodiment 3 of the present invention.

### DESCRIPTION OF EMBODIMENTS

Now, embodiments of the present invention will be described below in detail with reference to the accompanying drawings.

### Embodiment 1

With the present embodiment, a radio transmitting apparatus transmits an SC signal having been subjected to joint THP/transmission FDE, to a radio receiving apparatus. The radio transmitting apparatus also performs THP using matrix B that minimizes the total mean square error of all symbols, between a transmission block prior to THP, and a received block in the radio receiving apparatus. That is to say, with the present embodiment, a radio transmitting apparatus performs THP based on an MMSE (Minimum Mean Square Error) criterion to minimize the total value of the respective mean square errors of a plurality of symbols forming one transmission block.

First, the principle of joint THP/transmission based on an MMSE criterion according to the present embodiment will be described.

In joint THP/transmission FDE, a radio transmitting apparatus performs both THP and FDE. In joint THP/transmission FDE, lower triangular matrix L and unitary matrix Q, obtained by performing LQ decomposition of an equalization channel matrix formed with an FDE weight and channel impulse response to use in FDE for a transmission block comprised of N_{C} symbols, and average channel quality reported from the radio receiving apparatus, are used.

To be more specific, in THP, a radio transmitting apparatus performs processing, including modulo operation, for a transmission block comprised of N_{C} symbols, that is, for a data symbol vector obtained by modulating transmission data, using lower triangular matrix L and average channel quality. By this means, a data symbol vector is converted into signal vector x=[x(0), x(1), . . . , x(N_{C}−1)]^{T}. “N_{C}” is the number of FFT points (the number of IFFT points), and the superscript “T” is the transpose of the vector. Then, a radio transmitting apparatus multiplies signal vector x by Hermitian transposed matrix Q^{H} of unitary matrix Q and power equalization coefficient for equalizing the power of signal vector x. The superscript H is the Hermitian transpose.

On the other hand, in transmission FDE, a radio transmitting apparatus performs an N_{C}-point FFT on the signal vector ΩQ^{H}x after the multiplication, and converts the time domain signal into a frequency domain signal. Then, a radio transmitting apparatus multiplies the frequency domain signal by an FDE weight, performs an N_{C}-point IFFT on the frequency domain signal after the multiplication, and converts the frequency domain signal back to a time domain signal. Also, the radio transmitting apparatus transmits the time domain signal by attaching a cyclic prefix (“CP”) to it.

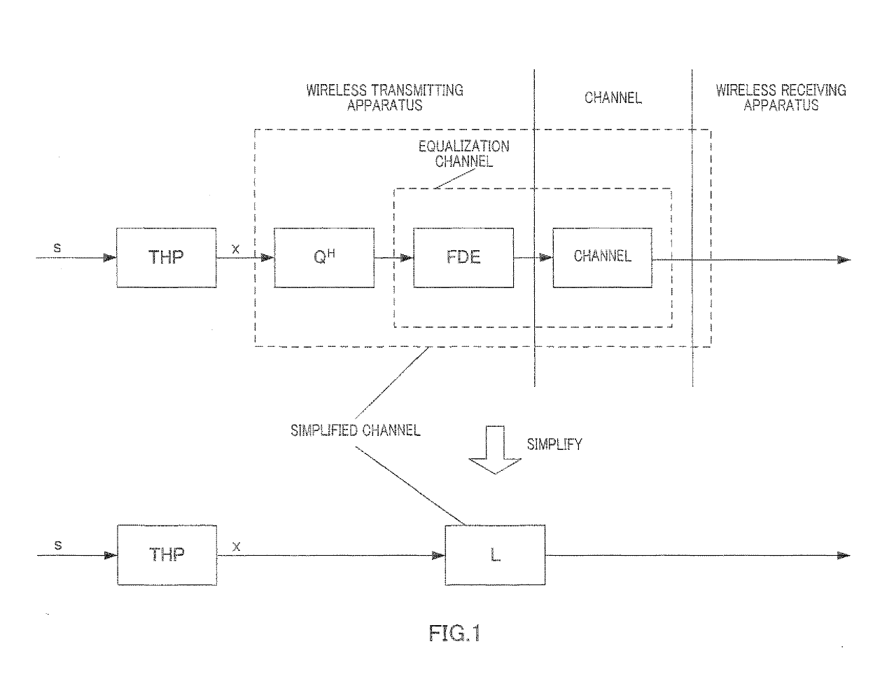

That is to say, with the present embodiment, as shown in the upper part of FIG. 1, signal vector x after THP is transmitted to a radio receiving apparatus via Hermitian transposed matrix Q^{H} of unitary matrix Q and an equalization channel. With the present embodiment, an equalization channel multiplied by matrix Q^{H} is used as a simplified channel. That is to say, the channel where signal vector x after THP propagates is formed with matrix Q^{H}, FDE weight to use in FDE and channel impulse response. Here, multiplying the equalization channel by matrix Q^{H} gives lower triangular matrix L. That is to say, with the present embodiment, as shown in the lower part of FIG. 1, signal vector x after THP propagates through a channel represented by lower triangular matrix L and is transmitted to a radio receiving apparatus.

The radio receiving apparatus removes the CP from the received signal and then processes the received signal sequence, including performing modulo operation, and demodulates the signal after the modulo operation.

<Transmission Signal>

A radio transmitting apparatus performs THP for a data symbol vector using lower triangular matrix L obtained by LQ-decomposing an equalization channel matrix, and matrix B calculated from average channel quality, and acquires signal vector x=[x(0), x(1), . . . , x(N_{C}−1)]^{T} after THP, represented by following equation 1.

$$\begin{matrix}( Equation 1 ) & \\ \begin{matrix}x = {\{ diag ( B ) \}}^{- 1} ( s - ( B - diag ( B ) ) x + 2 {Mz}_{t} ) \\ = {B}^{- 1} ( s + 2 {Mz}_{t} )\end{matrix} & [ 1 ]\end{matrix}$$

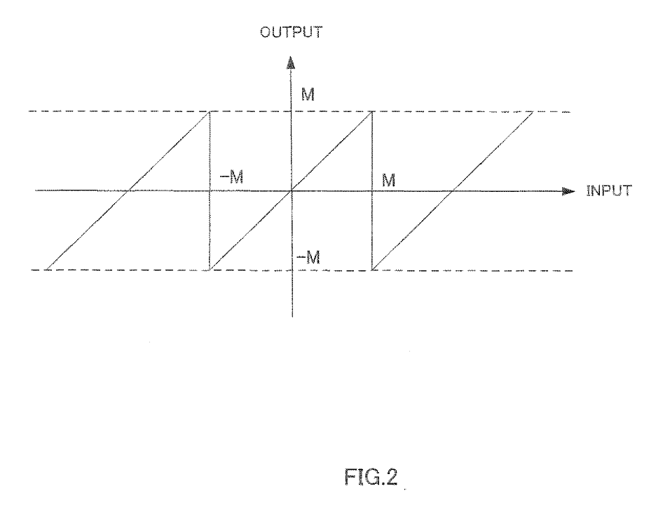

Here, diag( ) represents a diagonal matrix which has given elements (matrix B in equation 1) as diagonal elements and in which all elements besides the diagonal elements are 0's, and 2 Mzₜ represents a modulo operation circuit. FIG. 2 shows input and output characteristics of a modulo operation circuit. In modulo operation, the real part and the imaginary part of a signal obtained by feedback filter loop processing are converted into an [−M, M] range to stabilize THP output. 2 Mz_{t is a (N}_{c}×1) vector, and the real part and imaginary part of zₜ are both represented by integers.

Matrix B to use in THP is given by following equation 2. How matrix B is derived will be described later.

$$\begin{matrix}( Equation 2 ) & \\ B = {L}^{- H} [ {L}^{H} L + {( \frac{{E}_{s}}{{N}_{0}} )}^{- 1} I ] & [ 2 ]\end{matrix}$$

Here, I is a (N_{c}×N_{c}) unit matrix, and Eₛ/N₀ is the signal energy to noise power spectrum density ratio per symbol, which shows average channel quality. Also, L is a lower triangular matrix obtained by LQ-decomposing equalization channel matrix ĥ, and equalization channel matrix ĥ, lower triangular matrix L and unitary matrix Q hold the relationship of equation 3.

$$\begin{matrix}( Equation 3 ) & \\ \hat{h} = LQ = [ \begin{matrix}{l}_{0 , 0} & & & 0 \\ ⋮ & {l}_{1 , 1} & & \\ ⋮ & & ⋱ & \\ {l}_{{N}_{c} - 1 , 0} & … & … & {l}_{{N}_{c} - 1 , {N}_{c} - 1}\end{matrix} ] [ \begin{matrix}{q}_{0 , 0} & … & … & {q}_{0 , {N}_{c} - 1} \\ ⋮ & {q}_{1 , 1} & & ⋮ \\ ⋮ & & ⋱ & ⋮ \\ {q}_{{N}_{c} , 1 , 0} & … & … & {q}_{{N}_{c} - 1 , {N}_{c} - 1}\end{matrix} ] & [ 3 ]\end{matrix}$$

Equalization channel ĥ is given by following equation 4.

$$\begin{matrix}( Equation 4 ) & \\ \hat{h} = [ \begin{matrix}{\hat{h}}_{0} & {\hat{h}}_{{N}_{c} - 1} & {\hat{h}}_{{N}_{c} - 2} & & ⋮ & & {\hat{h}}_{1} \\ {\hat{h}}_{1} & {\hat{h}}_{0} & {\hat{h}}_{{N}_{c - 1}} & ⋱ & ⋮ & & ⋮ \\ ⋮ & {\hat{h}}_{1} & {\hat{h}}_{0} & ⋱ & {\hat{h}}_{{N}_{c} - 2} & & ⋮ \\ ⋮ & ⋮ & {\hat{h}}_{1} & ⋱ & {\hat{h}}_{{N}_{c} - 1} & ⋱ & ⋮ \\ ⋮ & ⋮ & ⋮ & ⋱ & {\hat{h}}_{0} & ⋱ & {\hat{h}}_{{N}_{c} - 2} \\ {\hat{h}}_{{N}_{c} - 2} & ⋮ & ⋮ & & {\hat{h}}_{1} & ⋱ & {\hat{h}}_{{N}_{c} - 1} \\ {\hat{h}}_{{N}_{c} - 1} & {\hat{h}}_{{N}_{c} - 2} & ⋮ & & ⋮ & ⋱ & {\hat{h}}_{0}\end{matrix} ] & [ 4 ]\end{matrix}$$

Furthermore, element ĥ₁ in above equation 4 is given by following equation 5.

$$\begin{matrix}( Equation 5 ) & \\ {\hat{h}}_{l} = \frac{1}{{N}_{c}} {\sum }_{k = 0}^{{N}_{c } - 1} w ( k ) H ( k ) exp ( j2π k \frac{l}{{N}_{c}} ) & [ 5 ]\end{matrix}$$

Here, H(k) (k=0˜N_{c}−1) is the channel gain of a k-th orthogonal frequency component, and w(k) (k=0˜N_{c}−1) is an FDE weight. It is equally possible to use, for example, a zero forcing (“ZF”) weight, a maximum ratio combining (“MRC”) weight, an equal gain combining (“EGC”) weight, or a minimum mean square error (“MMSE”) weight as an FDE weight.

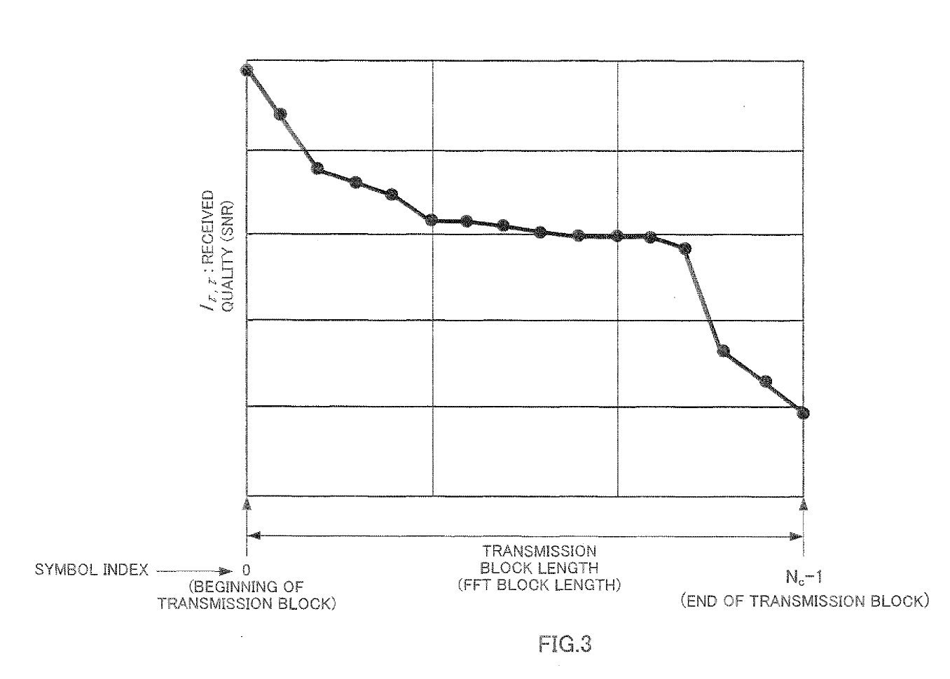

In lower triangular matrix L of FIG. 1 representing a simplified channel, diagonal elements 1_{τ,τ} (τ=0˜N_{c}−1) show the received quality (SNR) of signal vector x (that is, a transmission block) after THP, as shown in FIG. 3. As shown in FIG. 3, diagonal elements 1_{τ,τ} of lower triangular matrix L show the SNRs of a transmission block, including the higher SNRs in the first half of the transmission block and the lower SNRs in the second half of the transmission block. That is to say, in the channel of equation 3 represented by lower triangular matrix L, received quality (diagonal elements in lower triangular matrix L) is not fixed between symbols forming a transmission block.

Also, referring to above equation 3, lower triangular elements in lower triangular matrix L besides the diagonal elements represent residual ISI in the transmission block. To be more specific, in lower triangular matrix L of equation 3, 1_{1,0} is an residual ISI component of the symbol of symbol index 1 shown in FIG. 3, 1_{2,0} and 1_{2,1} are residual ISI components of the symbol of symbol index 2 shown in FIG. 3, and 1_{3,0} to 1_{3,2} are residual ISI components of the symbol of symbol index 3 shown in FIG. 3. Likewise, 1_{Nc-1,0} to 1_{Nc-1,Nc-2} are residual ISI components of the symbol of symbol index N_{c}−1 shown in FIG. 3. The same applies to the symbols of symbol indices 4˜N_{c}−2. That is to say, in the channel of equation 3 represented by lower triangular matrix L, in the symbols to form a transmission block, symbols in the second half of the transmission block have more residual ISI components. In other words, residual ISI components are unevenly distributed in a transmission block.

Next, a radio transmitting apparatus multiples signal vector x by power equalization coefficient Ω and Hermitian transposed matrix Q^{H} of unitary matrix Q. For example, power equalization coefficient Ω is given by following equation 6 using diagonal element b_{τ,τ} (τ=0˜N_{c}−1) of matrix B (equation 2) to use in THP. Here, diagonal element b_{τ,τ} in matrix B shows the received quality (SNR) of each symbol forming a transmission block.

$$\begin{matrix}( Equation 6 ) & \\ Ω = \sqrt{{N}_{c } / {\sum }_{τ = 0}^{{N}_{c} - 1} ( 1 / {\vert {b}_{τ , τ} \vert}^{2} )} & [ 6 ]\end{matrix}$$

Then, a radio transmitting apparatus performs FDE on signal vector ΩQ^{H}x. That is to say, with signal vector ΩQ^{H}x, a radio transmitting apparatus performs an N_{c}-point FFT, a multiplication by FDE weight w(k) and an N_{c}-point IFFT. Now, assume that a transmission data symbol vector after FDE is s′=[s′(0), s′(1), . . . , s′(N_{C}−1)]^{T}. Then, the radio transmitting apparatus attaches a CP to transmission data symbol vector s′ and transmits the result to a radio receiving apparatus.

<Channel>

A radio channel is formed with L individual paths, and, assuming that the gain and delay time of path 1 are h₁ and τ₁, respectively, channel response h(τ) is given by following equation 7. δ(τ) is a delta function.

$$\begin{matrix}( Equation 7 ) & \\ h ( τ ) = {\sum }_{l = 0}^{L - 1} {h}_{l} δ ( τ - {τ}_{l} ) & [ 7 ]\end{matrix}$$

<Received Signal>

Signal vector r=[r(0), r(1), . . . , r(N_{C}−1)]^{T}, which is a received block having propagated through a radio channel represented by equation 7, received by an antenna of a radio receiving apparatus and had the CP removed, is represented by following equation (8).

$$\begin{matrix}( Equation 8 ) & \\ \begin{matrix}r = \sqrt{\frac{2 {E}_{s}}{{T}_{s}}} {hs}^{′} + n \\ = \sqrt{\frac{2 {E}_{s}}{{T}_{s}}} Ω \hat{h} {Q}^{H} x + n \\ = \sqrt{\frac{2 {E}_{s}}{{T}_{s}}} Ω {LB}^{- 1} ( s + 2 {Mz}_{t} ) + n\end{matrix} & [ 8 ]\end{matrix}$$

Here, Eₛ is average symbol energy, Tₛ is the symbol length, and n(=[n(0), n(1), . . . , n(N_{C}−1)]^{T}) is a noise vector. The elements n(t) of noise vector n are zero-mean complex white Gaussian noise with variance of 2N₀/Tₛ. N₀ is one-sided noise power spectrum density. Also, h is a (N_{c}×N_{c}) cyclic channel impulse response matrix and can be represented by following equation 9.

$$\begin{matrix}( Equation 9 ) & \\ h = [ \begin{matrix}{h}_{0} & 0 & … & 0 & {h}_{L - 1} & … & {h}_{1} \\ {h}_{1} & {h}_{0} & 0 & & ⋱ & ⋱ & ⋮ \\ ⋮ & {h}_{1} & {h}_{0} & ⋱ & & ⋱ & {h}_{L - 1} \\ {h}_{L - 1} & ⋮ & {h}_{1} & ⋱ & 0 & & 0 \\ 0 & {h}_{L - 1} & ⋮ & ⋱ & {h}_{0} & ⋱ & ⋮ \\ ⋮ & ⋱ & ⋱ & & {h}_{1} & ⋱ & 0 \\ 0 & … & 0 & {h}_{L - 1} & ⋮ & ⋱ & {h}_{0}\end{matrix} ] & [ 9 ]\end{matrix}$$

Then, a radio receiving apparatus acquires soft decision symbol vector ŝ represented by following equation 10 by inputting received signal vector r in a modulo operation circuit.

$$\begin{matrix}( Equation 10 ) & \\ \hat{s} = {( \frac{2 {E}_{s}}{{T}_{s}} {Ω}^{2} )}^{\frac{1}{2}} r + 2 {Mz}_{r} & [ 10 ]\end{matrix}$$

Here, 2 Mzᵣ is a (N_{c}×1) vector, and the real part and imaginary part of zᵣ are represented by integers.

Then, a radio receiving apparatus demodulates soft decision symbol vector ŝ.

<Calculation of Matrix B in THP Based on MMSE Criterion>

In THP based on an MMSE criterion, matrix B to minimize the total mean square error of all symbols, between a transmission block prior to THP, and a received block in a radio receiving apparatus, is used. To be more specific, error vector e between a transmission block prior to THP and a received block in the radio receiving apparatus is used. A correction term (2 Mzₜ) is introduced in error vector e, to prevent the error being influenced by the modulo operation in the radio transmitting apparatus.

$$\begin{matrix}( Equation 11 ) & \\ e = \frac{r - \sqrt{2 {E}_{s} / {T}_{s}} C ( s + 2 {Mz}_{t} )}{\sqrt{2 {E}_{s} / {T}_{s}} C} ≅ ( {LB}^{- 1} - I ) s + \frac{1}{\sqrt{2 {E}_{s} / {T}_{s}} C} n & [ 11 ]\end{matrix}$$

Here, C is a constant.

Then, matrix B to minimize all elements of error vector e, that is, total mean square error e of all symbols (following equation 12), is determined.

$$\begin{matrix}( Equation 12 ) & \\ e = {\sum }_{i = 0}^{{N}_{c} - 1} E [ {\vert {e}_{i} \vert}^{2} ] = tr [ E [ {ee}^{H} ] ] & [ 12 ]\end{matrix}$$

Here, E[ ] is an ensemble average and tr[ ] is a matrix trace. In THP based on an MMSE criterion according to the present embodiment, error vector e, which represents the difference between data symbol vector s (transmission data block prior to THP) and received signal vector r which has propagated through lower triangular matrix L and to which noise vector n is added. A correction term (2 Mzₜ) is introduced in error vector e, to prevent the error being influenced by the modulo operation in the radio transmitting apparatus. That is, a radio transmitting apparatus calculates matrix B which suppresses both residual ISI components in the channel represented by lower triangular matrix L, and SNR deterioration due to noise vector n.

By integrating both sides of above equation 12, following equation 13 is given.

$$\begin{matrix}( Equation 13 ) & \\ \frac{\partial e}{\partial {B}^{- 1}} = {B}^{- H} {L}^{H} L - L + ( \frac{{E}_{s}}{{N}_{0}} ) {B}^{- H} & [ 13 ]\end{matrix}$$

In above equation 13, by calculating ∂e/∂B⁻¹=0, matrix B and inverse matrix B⁻¹ in THP based on an MMSE criterion, are given by following equation 14.

$$\begin{matrix}( Equation 14 ) & \\ {B}^{- 1} = {[ {L}^{H} L + {( \frac{{E}_{s}}{{N}_{0}} )}^{- 1} I ]}^{- 1} {L}^{H} ⇔ B = {L}^{- H} [ {L}^{H} L + {( \frac{{E}_{s}}{{N}_{0}} )}^{- 1} I ] . & [ 14 ]\end{matrix}$$

As shown with above equation 14, when an average SNR (or Eₛ/N₀) is low, B⁻¹ becomes close to (Eₛ/N₀)L^{H}. That is to say, in THP processing represented by equation 1, an average SNR (Eₛ/N₀) and L^{H} included in matrix B contribute to improving the SNR of signal vector x, so that the SNR characteristic of the channel represented by lower triangular matrix L can be corrected. That is to say, when an average SNR (Eₛ/N₀) is low, THP based on an MMSE criterion works to improve the SNR more preferentially than cancelling residual ISI. On the other hand, when an average SNR (Eₛ/N₀) is low, B⁻¹ becomes close to L⁻¹. That is to say, in THP processing represented by equation 1, L⁻¹ included in matrix B cancels the channel represented by lower triangular matrix, so that it is possible to cancel the residual ISI included in the channel represented by lower triangular matrix L completely. That is to say, when an average SNR (Eₛ/N₀) is high, THP based on an MMSE criterion works to cancel residual ISI more preferentially than improving the SNR.

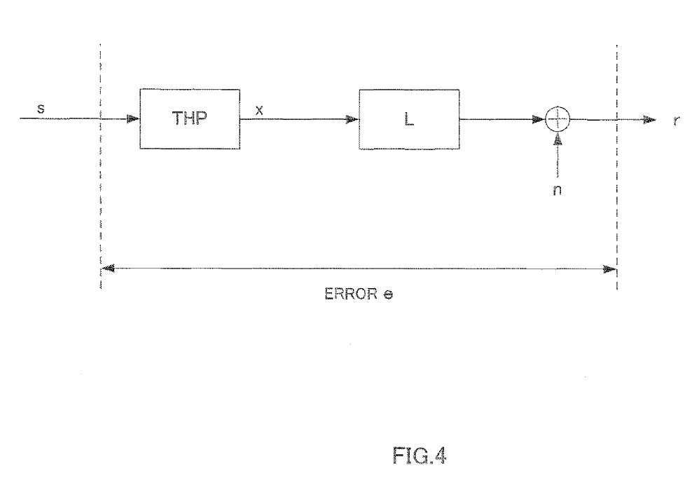

Thus, in THP based on an MMSE criterion, a channel in which residual ISI components are not uniform in a transmission block and in which the SNR is not constant in a transmission block (that is, the channel represented by lower triangular matrix in FIG. 4), and noise (noise vector n shown in FIG. 4), are taken into account. To be more specific, THP is performed based on an MMSE criterion which minimizes the total mean square error of all symbols, between a transmission block and a received block in a radio receiving apparatus. By this means, it is possible to cancel residual ISI that is distributed unevenly in a transmission block and distribute power between symbols in the transmission block, thereby reducing SNR deterioration in the second half of the transmission block shown in FIG. 3.

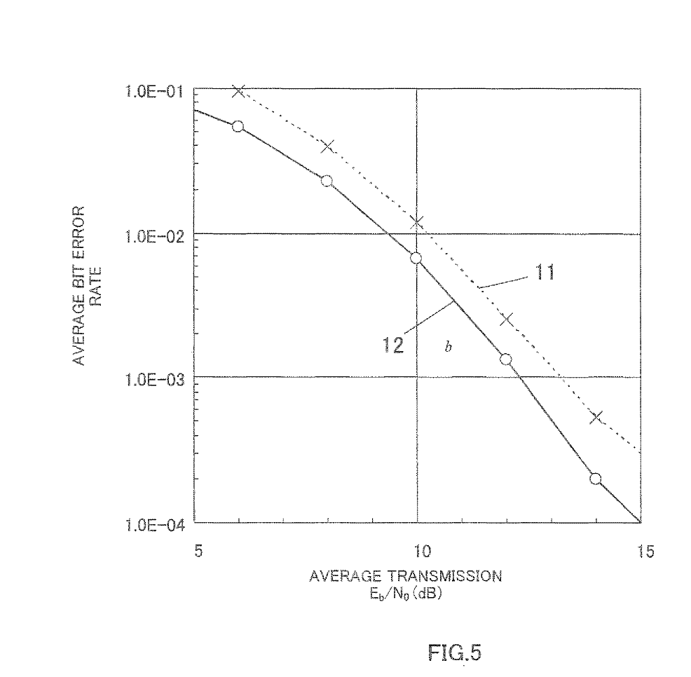

In a computer simulation conducted by the present inventors, average bit error rate 11 in joint THP/transmission FDE not inserting a dummy symbol near the end of a transmission block, and average bit error rate 12 in joint THP/transmission FDE according to the present embodiment, are as shown in FIG. 5. Here, between Eₛ/N₀ and signal energy to noise power spectrum density ratio E_{b}/N₀ per bit, the relationship of Eₛ/N₀=10 log₁₀(M)+E_{b}/N₀ [dB] holds. M is the M-ary modulation value, which shows the number of bits per symbol (for example, M=2 in QPSK and M=4 in 16 QAM). It is clear from this computer simulation result that, whatever E_{b}/N₀ is, average bit error rate 12 shows a better characteristic than average bit error rate 11. Thus, THP based on an MMSE criterion improves the SNR when an average SNR is low and cancels residual ISI when an average SNR is high, thereby improving error rate performance.

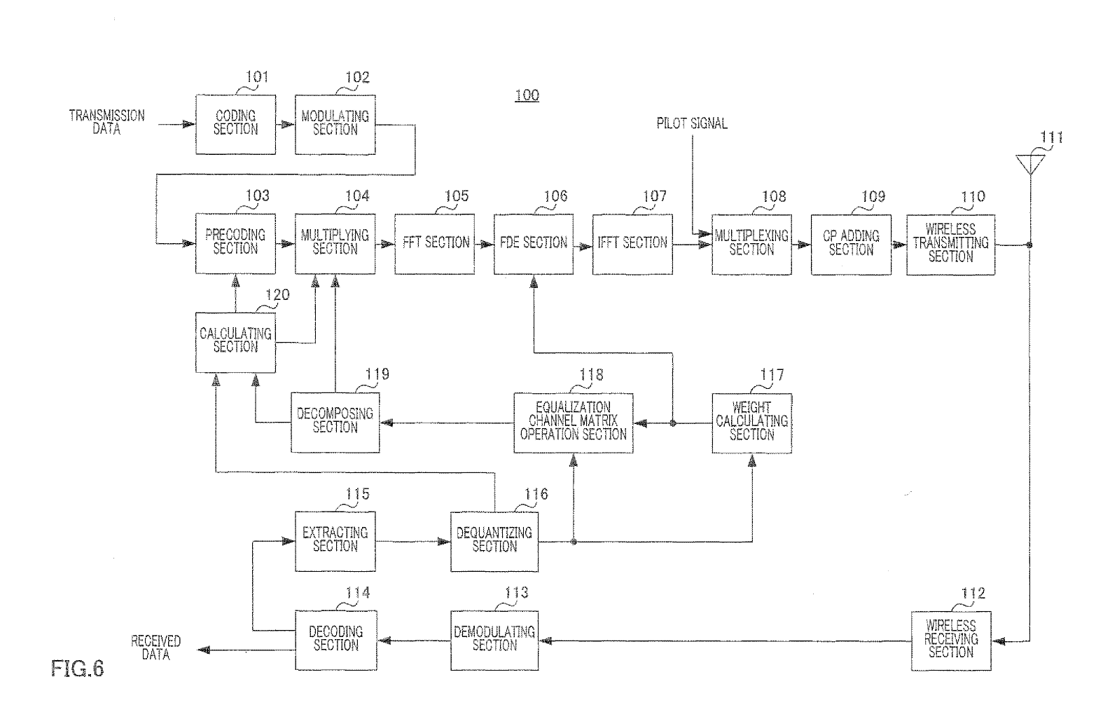

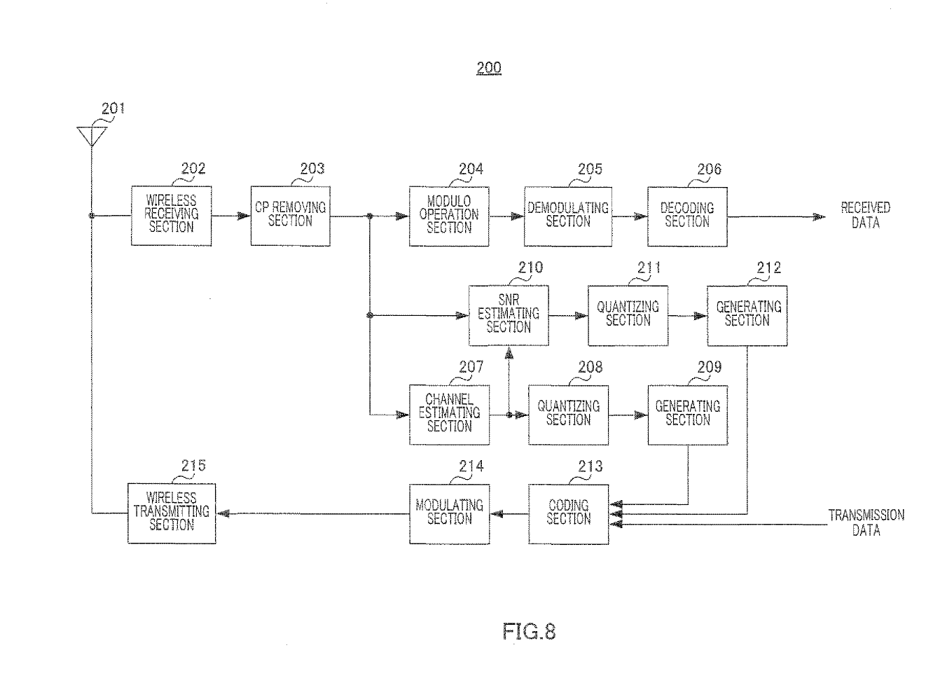

Next, the configurations of a radio transmitting apparatus and a radio receiving apparatus according to the present embodiment will be described. FIG. 6 shows a configuration of radio transmitting apparatus 100 according to the present embodiment, and FIG. 8 shows a configuration of radio receiving apparatus 200 according to the present embodiment.

First, radio transmitting apparatus 100 will be described. In radio transmitting apparatus 100 shown in FIG. 6, coding section 101 encodes transmission data and outputs encoded transmission data to modulating section 102.

Modulating section 102 modulates the encoded transmission data received as input from coding section 101, and generates a data symbol sequence. Then, modulating section 102 outputs the data symbol sequence to precoding section 103.

Precoding section 103 divides the data symbol sequence received as input from modulating section 102 into N_{c} transmission blocks (data symbol vector s), which matches the number of symbols to be subject to the FFT in FFT section 105 described later (FFT block length). Precoding section 103 performs THP based on an MMSE criterion (hereinafter “MMSE-THP”) for a transmission block using matrix B (and matrix B⁻¹) of equation 14 received as input from calculating section 120.

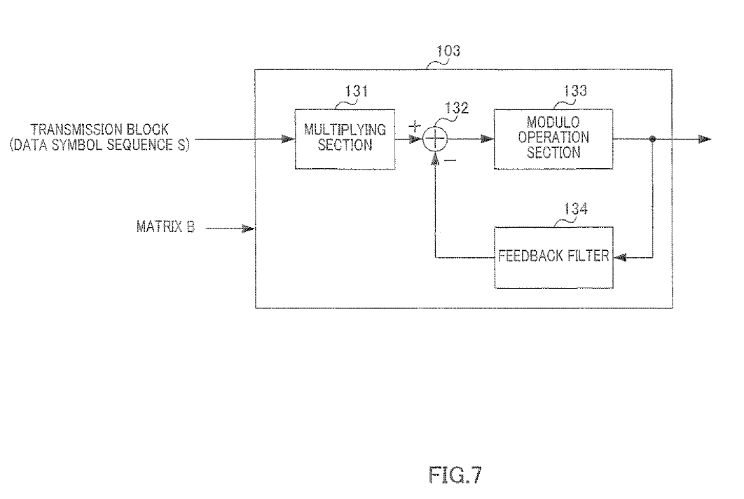

FIG. 7 is a block diagram showing an internal configuration of precoding section 103. Multiplying section 131 multiples a transmission block (data symbol vector s) by {diag(B)}⁻¹ using matrix B received as input from calculating section 120.

Adder 132 subtracts a signal component received as input from feedback filter 134, from a transmission block received as input from multiplying section 131. By means of this subtraction, residual ISI components after transmission FDE are cancelled.

Modulo operation section 133 applies modulo operation of input and output characteristics shown in FIG. 2, to the transmission block after the subtraction. Also, modulo operation section 133 outputs the transmission block after the operation, to feedback filter 134 and multiplying section 104 (FIG. 6).

Feedback filter 134 multiplies the transmission block received as input from modulo operation section 133, by {diag(B)}⁻¹(B−diag(B)). That is to say, by performing filtering processing in feedback filter 134, only the residual ISI components in the transmission block remain. Then, feedback filter 134 outputs the signal components after the filtering to adder 132.

Then, precoding section 103 outputs transmission block x after THP, represented by equation 1, to multiplying section 104.

Multiplying section 104 multiplies the transmission block after THP, received as input from precoding section 103, by Hermitian transposed matrix Q^{H} of unitary matrix Q (equation 3) received as input from decomposing section 119, and by power equalization coefficient Ω (equation 6) that is calculated in calculating section 120 as in equation 5 using diagonal elements of matrix B (equation 14). Then, multiplying section 104 outputs transmission block ΩQ^{H}x after the multiplication, to FFT section 105.

FFT section 105 performs an N_{c}-point FFT on transmission block ΩQ^{H}x after the multiplication, received as input from multiplying section 104, and converts a time domain signal having a block length of N_{c} into a frequency domain signal comprised of N_{c} frequency components. Then, FFT section 105 outputs the frequency domain signal to FDE section 106.

FDE section 106 performs FDE for the frequency domain signal received as input from FFT section 105 using FDE weight w(k) (k=0˜N_{c}−1) received as input from weight calculating section 117. To be more specific, FDE section 106 multiplies the frequency components of the frequency domain signal by FDE weight w(k). Then, FDE section 106 outputs the frequency domain signal after FDE, to IFFT section 107.

IFFT section 107 performs an IFFT on the frequency domain signal received as input from FDE section 106 per block, that is, performs an N_{c}-point FFT, and converts the frequency domain signal into a transmission block, which is a time domain signal. Then, IFFT section 107 outputs the transmission block after the IFFT (transmission data symbol vector s′) to multiplexing section 108.

Multiplexing section 108 multiplexes the transmission block received as input from IFFT section 107 and a pilot signal, and outputs the transmission block after the multiplexing to CP adding section 109.

CP adding section 109 attaches an end portion of the transmission block received as input from multiplexing section 108 to the beginning of that transmission block as a CP.

Radio transmitting section 110 performs radio transmission processing of the transmission block with a CP, including D/A conversion, amplification and up-conversion, and transmits the result to radio receiving apparatus 200 (FIG. 8) from antenna 111. That is to say, radio transmitting section 110 transmits an SC signal with a CP to radio receiving apparatus 200.

On the other hand, radio receiving section 112 receives the signal transmitted from radio receiving apparatus 200 (FIG. 8) and performs radio receiving processing of the received signal including down conversion and A/D conversion. Then, radio receiving section 112 outputs the signal after radio receiving processing to demodulating section 113.

The received signal includes a data signal and a control signal which contains SNR information that shows an average SNR and CIR information that shows the CIR.

Demodulating section 113 demodulates the received signal received as input from radio receiving section 112 and outputs the demodulated signal to decoding section 114.

Decoding section 114 decodes the signal received as input from demodulating section 113. Then, decoding section 114 outputs the decoded data signal as received data and outputs the decoded control signal to extracting section 115.

Extracting section 115 extracts the SNR information and CIR information from control signal received as input from decoding section 114. Then, extracting section 115 outputs the extracted SNR information and CIR information to dequantizing section 116.

Dequantizing section 116 dequantizes the CIR information and SNR information received as input from extracting section 115 and finds the CIR and average SNR. Then, dequantizing section 116 output the CIR to weight calculating section 117 and equalization channel matrix operation section 118, and outputs the average SNR to calculating section 120.

Weight calculating section 117 calculates FDE weight w(k) (k=0˜N_{c}−1) to use in FDE for a transmission block using the CIR received as input from dequantizing section 116. Then, weight calculating section 117 outputs FDE weight w(k) to equalization channel matrix operation section 118 and FDE section 106.

Equalization channel matrix operation section 118 calculates an equalization channel matrix representing an equalization channel formed with the FDE weight received as input from weight calculating section 117 and the CIR received as input from dequantizing section 116. To be more specific, equalization channel matrix operation section 118 calculates each element ĥ₁ of equalization channel matrix ĥ using FDE weight w(k), and channel gain H(k) by applying the FFT to the CIR, and generates equalization channel matrix ĥ represented by equation 4. Then, equalization channel matrix operation section 118 outputs equalization channel matrix ĥ to decomposing section 119.

As represented by equation 3, decomposing section 119 acquires lower triangular matrix L and unitary matrix Q by LQ decomposing equalization channel matrix ĥ received as input from equalization channel matrix operation section 118. As explained earlier, lower triangular matrix L is comprised of diagonal elements that represent the SNRs of a transmission block, including the higher SNRs in the first half of the transmission block and the lower SNRs in the second half of the transmission block, and elements that represent the residual ISI of the transmission block. Then, decomposing section 119 outputs lower triangular matrix L to calculating section 120 and unitary matrix Q to multiplying section 104.

Using lower triangular matrix L received as input from decomposing section 119 and an average SNR received as input from dequantizing section 116, calculating section 120 calculates matrix B that minimizes the total mean square error of all symbols, between a transmission block prior to THP and a received block in radio receiving apparatus 200, and inverse matrix B⁻¹ of matrix B. To be more specific, calculating section 120 calculates matrix B and matrix B⁻¹ represented by equation 14 using lower triangular matrix L and average SNR (Eₛ/N₀). Furthermore, calculating section 120 calculates power equalization coefficient Ω represented by equation 6 using diagonal elements b_{τ,τ} (τ=0˜N_{c}−1) of calculated matrix B. Calculating section 120 outputs matrix B and matrix B⁻¹ to precoding section 103, and outputs power equalization coefficient Ω to multiplying section 104.

Next, radio receiving apparatus 200 will be described. In radio receiving apparatus 200 shown in FIG. 8, radio receiving section 202 receives an SC signal transmitted from radio transmitting apparatus 100 (FIG. 6), that is to say, receives a block-unit symbol sequence, via antenna 201, and performs radio receiving processing of the symbol sequence including down conversion and A/D conversion.

CP removing section 203 removes the CP from the symbol sequence after the radio receiving processing, and outputs the symbol sequence without a CP (received signal vector r represented by equation 8) to modulo operation section 204, channel estimating section 207 and SNR estimating section 210.

Modulo operation section 204 applies modulo operation to the symbol sequence received as input from CP removing section 203, and outputs the symbol sequence after the operation (soft decision symbol vector represented by equation 10) to demodulating section 205.

Demodulating section 205 demodulates the symbol sequence received as input from modulo operation section 204, and outputs the demodulated data signal to decoding section 206.

Decoding section 206 acquires the received data by decoding the data signal received as input from demodulating section 205.

Channel estimating section 207 extracts the pilot signal multiplexed upon the symbol sequence received as input from CP removing section 203, and estimates the CIR using the extracted pilot signal. Then, channel estimating section 207 outputs the estimated CIR to quantizing section 208 and SNR estimating section 210.

Quantizing section 208 quantizes the CIR received as input from channel estimating section 207 and outputs the quantized CIR (bit sequence) to generating section 209.

Generating section 209 generates CIR information representing the quantized CIR received as input from quantizing section 208. Generating section 209 outputs the generated CIR information to coding section 213.

SNR estimating section 210 extracts the pilot signal multiplexed upon the symbol sequence received as input from CP removing section 203 and estimates average SNR (Eₛ/N₀) using the extracted pilot signal and the CIR received as input from channel estimating section 207. Then, SNR estimating section 210 output estimated average SNR (Eₛ/N₀) to quantizing section 211.

Quantizing section 211 quantizes the average SNR received as input from SNR estimating section 210 and outputs the quantized average SNR (bit sequence) to generating section 212.

Generating section 212 generates SNR information, which represents the quantized average SNR received as input from quantizing section 211. Then, generating section 212 outputs the generated SNR information to coding section 213.

Coding section 213 encodes transmission data and a control signal including the CIR information received as input from generating section 209 and the SNR information received as input from generating section 212, and outputs the coded signal to modulating section 214.

Modulating section 214 modulates the signal received as input from coding section 213 and outputs the modulated signal to radio transmitting section 215.

Radio transmitting section 215 performs radio transmission processing of the signal received as input from modulating section 214, including D/A conversion, amplification and up-conversion, and transmits the result to radio transmitting apparatus 100 (FIG. 6) from antenna 201.

Thus, in mobile communication in which a channel represented by lower triangular matrix L (FIG. 3) is subject to radio communication, radio transmitting apparatus 100 performs MMSE-THP to cancel residual ISI and improve the SNR based on an average SNR and CIR reported from radio receiving apparatus 200. To be more specific, MMSE-THP improves the SNR more preferentially when average SNR is low. On the other hand, when an average SNR is high, MMSE-THP cancels residual ISI more preferentially. That is, by using MMSE-THP, it is possible to achieve both a residual ISI suppression effect and an SNR improvement effect based on average SNR fluctuation.

By this means, with the present embodiment, a radio transmitting apparatus performs THP based on an MMSE-criterion which minimizes the total mean square error of all symbols, between a transmission block and a received block in a radio receiving apparatus. By using MMSE-THP, it is possible to cancel residual ISI after FDE, and, furthermore, by improving the SNR, prevent error rate performance deterioration in the second half of a transmission block due to the use of FDE and THP in combination. Then, with the present embodiment, in mobile communication combining FDE and THP, it is possible to prevent error rate performance deterioration without causing a decrease of data rate.

Furthermore, with the present embodiment, a radio transmitting apparatus calculates matrix B using the CIR and average SNR reported from a radio receiving apparatus. That is to say, a radio receiving apparatus has only to report the CIR and average SNR to a radio transmitting apparatus, so that it is possible to improve transmission efficiency.

Furthermore, with the present embodiment, a radio transmitting apparatus calculates a power equalization coefficient using diagonal elements of matrix B as represented by equation 6. By this means, by using accurate power equalization coefficient Ω, the radio transmitting apparatus is able to perform transmission power control processing for a transmission block having been subjected to THE using matrix B.

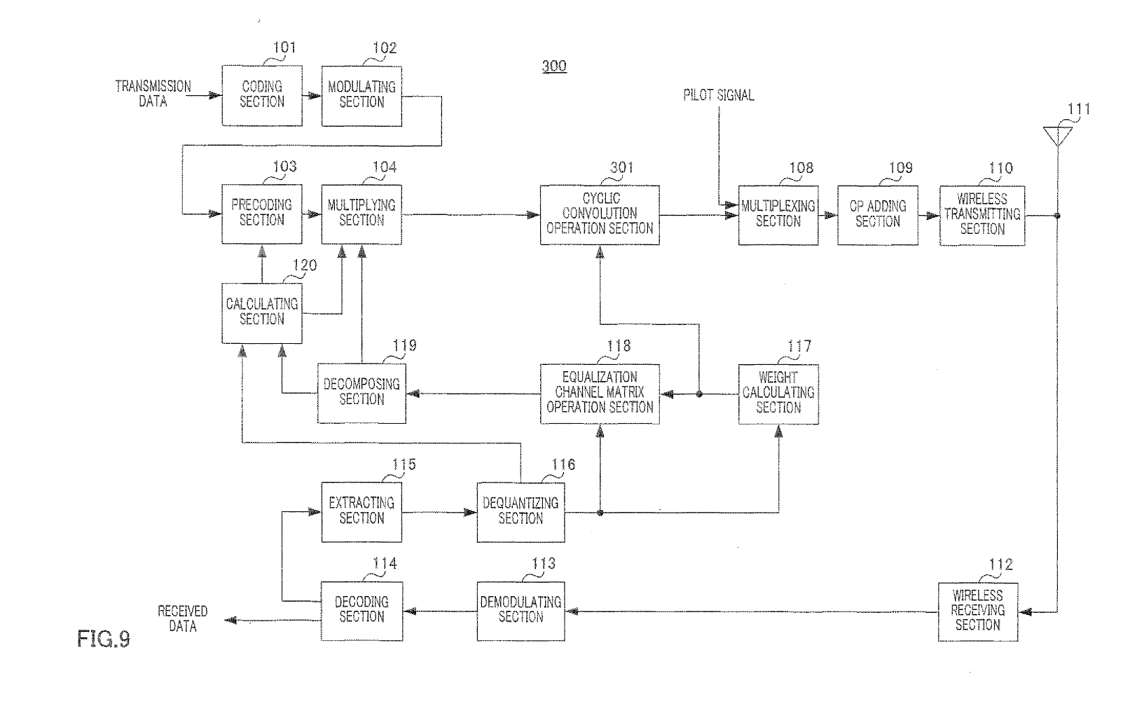

A case has been described with the present embodiment where FDE, which performs transmission equalization processing in the frequency domain, and MMSE-THP, are used in combination. However, with the present invention, it is equally possible to use a configuration to use time-domain transmission equalization processing and MMSE-THP in combination. FIG. 9 shows a configuration of radio transmitting apparatus 300 to use time domain transmission equalization processing and MMSE-THP in combination. Parts in FIG. 9 that are the same as in FIG. 6 will be assigned the same reference codes as in FIG. 6, and their explanations will be omitted. Parts that differ between FIG. 9 and FIG. 6 include that processing of calculating a time domain transmission equalization weight is added in weight calculating section 117 in FIG. 6, and that FFT section 105, FDE section 106 and IFFT section 107 are replaced by cyclic convolution operation section 301. To be more specific, weight calculating section 117 of radio transmitting apparatus 300 shown in FIG. 9 calculates FDE weight w(k) (k=0˜N_{c}−1) to use in FDE for a transmission block, using the CIR received as input from dequantizing section 116 (or CIR and average SNR). Then, by performing an IFFT upon FDE weight w(k), weight calculating section 117 converts FDE weight w(k) into a time domain component and calculates a time domain transmission equalization weight. Then, weight calculating section 117 outputs the time domain transmission equalization weight to cyclic convolution operation section 301 and outputs FDE weight w(k) to equalization channel matrix operation section 118. Cyclic convolution operation section 301 equalizes a transmission block in the time domain by performing a cyclic convolution operation of transmission block ΩQ^{H}x received as input from multiplying section 104 and the time domain transmission equalization weight received as input from weight calculating section 117. Then, cyclic convolution operation section 301 outputs the transmission block after the cyclic convolution operation (transmission data symbol vector s′), to multiplexing section 108. By this means, it is possible to use time domain transmission equalization processing and MMSE-THP in combination and achieve the same effect as by the present embodiment.

Furthermore, a case has been described with the present embodiment where a radio transmitting apparatus performs THP using matrix B that minimizes the total mean square error of all symbols, between a transmission block prior to THP, and a received block in a radio receiving apparatus. However, with the present invention, a radio transmitting apparatus may assign weights to the mean square errors of symbols, between a transmission block prior to THP and a received block in a radio receiving apparatus, and perform THP using matrix B that minimizes the total of the weighted mean square errors of all symbols. For example, it is possible to define total average square error e of all symbols represented by following equation using weighting coefficients αᵢ (i=0˜N_{c}−1) for the mean square errors of symbols in a transmission block.

$$\begin{matrix}( Equation 15 ) & \\ e = {\sum }_{i = 0}^{{N}_{c} - 1} {α}_{i} E [ {\vert {e}_{i} \vert}^{2} ] & [ 15 ]\end{matrix}$$

By this means, a radio transmitting apparatus achieves both a residual ISI suppression effect and an SNR improvement effect more efficiently by, for example, assigning weighting coefficients αᵢ (i=0˜N_{c}−1) to each symbol's mean square error according to the significance of each symbol's mean square error in a transmission block.

For example, upon assigning a weight to the mean square error of each symbol in a transmission block, a radio transmitting apparatus sets weighting coefficients αᵢ (i=0˜N_{c}−1) according to the scale of diagonal elements in lower triangular matrix L. For example, when a diagonal element of lower triangular matrix L is big (that is, when channel quality is high), an error in the channel has little impact on symbols in a transmission block, whereas, when a diagonal element in lower triangular matrix L is small (that is, when channel quality is low), an error in the channel has significant impact on transmission blocks in a transmission block. That is to say, when a diagonal element of lower triangular matrix L is smaller (that is, when channel quality is lower), the significance of the mean square error of the symbol corresponding to that diagonal element becomes higher. Consequently, when a diagonal element of lower triangular matrix L is smaller (that is, when channel quality is lower), it is possible to increase the value of weighting coefficient αᵢ (i=0˜N_{c}−1). By this means, it is possible to make the mean square error of each symbol in a transmission block reflect the influence of diagonal elements showing symbol-specific channel quality (for example, SNR) in a transmission block, thereby achieving a better SNR improvement effect.

Furthermore, when diagonal elements in lower triangular matrix L show the channel quality (for example, the SNR) of a transmission block including higher channel quality (for example, the SNR) in the first half of the transmission block and lower channel quality (for example, the SNR) in the second half of the transmission block, a radio transmitting apparatus may set a greater value for weighting coefficient αᵢ (i=N_{c}−1) for a symbol in the second half of a transmission block. By this means, it is possible to make the mean square error of each symbol in a transmission block reflect the influence of diagonal elements in lower triangular matrix L and achieve a better SNR improvement effect.

### Embodiment 2

A case will be described with the present embodiment where point-to-multipoint communication (for example, downlink transmission from a base station to a plurality of mobile communication terminals) is performed or multipoint-to-point communication (for example, uplink transmission from a plurality of mobile communication terminal to a base station) is performed.

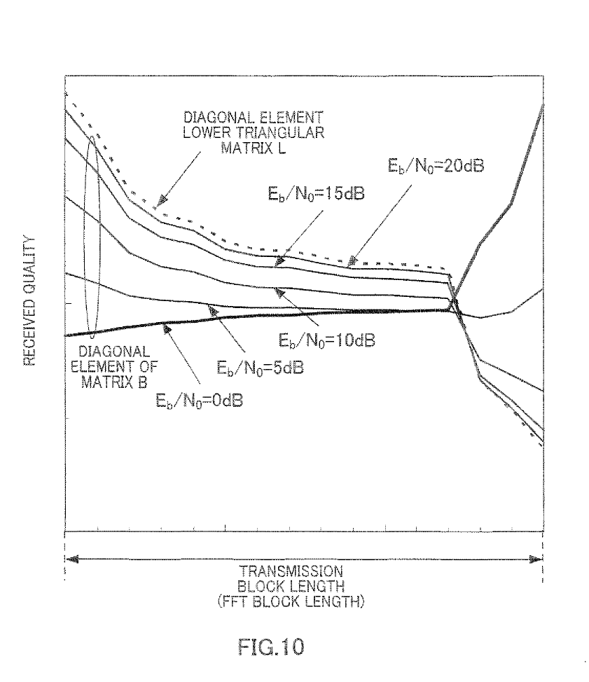

FIG. 10 shows diagonal elements (solid line) of matrix B to use in THP based on an MMSE criterion according to the present invention, and diagonal elements (dotted line) of lower triangular matrix. As shown in FIG. 10, the characteristics of diagonal elements of matrix B (that is to say, the received quality of each symbol forming a transmission block) vary according to E_{b}/N₀. For example, as shown in FIG. 10, when E_{b}/N₀=0 dB, the values of diagonal elements in matrix B become significantly bigger near the end of a transmission block. Furthermore, when E_{b}/N₀=5 dB, diagonal elements of matrix B in a transmission block are substantially fixed.

When E_{b}/N₀ is high (for example, when E_{b}/N₀=20), that is, when the distance between a radio transmitting apparatus and a radio receiving apparatus is short, the radio transmitting apparatus transmits a transmission block to the radio receiving apparatus by making the transmission power lower by transmission power control. In this case, even in a mobile communication system where a plurality of radio communication apparatuses including a radio transmitting apparatus and a radio receiving apparatus use the same frequency, a transmission block that is transmitted from a radio transmitting apparatus interferes little with a different radio communication apparatus. On the other hand, when E_{b}/N₀ is low (for example, when E_{b}/N₀=0), that is, when the distance between a radio transmitting apparatus and a radio receiving apparatus is long, the radio transmitting apparatus transmits a transmission block to the radio receiving apparatus by making the transmission power higher by transmission power control. In this case, in a mobile communication system where a plurality of radio communication apparatuses use the same frequency, a transmission block that is transmitted from a radio transmitting apparatus interferes with a different radio communication apparatus (for example, a radio communication apparatus having a shorter distance to the radio transmitting apparatus than a radio receiving apparatus). In particular, in the case of E_{b}/N₀=0 as shown in FIG. 10, the transmission power of a symbol near the end of a transmission block becomes even greater than the transmission power of symbols other than symbols near the end of the transmission block. Consequently, a different radio communication apparatus is subject to varying magnitudes of interference per symbol in a transmission block.

Each radio communication apparatus performs adaptive modulation and channel coding (“AMC”) control to select a modulation and channel coding scheme (“MCS”) set according to received quality, based on received signal power and also based on interference power. Consequently, when interference is produced in varying degrees in a transmission block, each radio communication apparatus is unable to select an optimal MCS set and therefore is unable to perform accurate AMC control. Consequently, the system throughput of the mobile communication system is deteriorated. Here, by exchanging information about interference between varying radio communication apparatuses, a control to minimize the interference against a plurality of radio communication apparatuses that use the same frequency, may be possible. However, when performing such control, it is necessary to perform complex control processing and calculation processing. Now, when E_{b}/N₀ is high (for example, when E_{b}/N₀=20), that is, when the distance between a radio transmitting apparatus and a radio receiving apparatus is short, the radio transmitting apparatus transmits a transmission block to the radio receiving apparatus by making the transmission power lower by transmission power control. In this case, even in a mobile communication system where a plurality of radio communication apparatuses including a radio transmitting apparatus and a radio receiving apparatus use the same frequency, a transmission block that is transmitted from a radio transmitting apparatus interferes little with a different radio communication apparatus. On the other band, when E_{b}/N₀ is low (for example, when E_{b}/N₀=0), that is, when the distance between a radio transmitting apparatus and a radio receiving apparatus is long, the radio transmitting apparatus transmits a transmission block to the radio receiving apparatus by making the transmission power higher by transmission power control. In this case, in a mobile communication system where a plurality of radio communication apparatuses use the same frequency, a transmission block that is transmitted from a radio transmitting apparatus interferes with a different radio communication apparatus (for example, a radio communication apparatus having a shorter distance to the radio transmitting apparatus than a radio receiving apparatus). In particular, in the case of E_{b}/N₀=0 as shown in FIG. 10, the transmission power of a symbol near the end of a transmission block becomes even greater than the transmission power of symbols other than symbols near the end of the transmission block. Consequently, a different radio communication apparatus is subject to varying magnitudes of interference per symbol in a transmission block.

So, with the present embodiment, a radio transmitting apparatus calculates matrix B using average SNR (Eₛ/N₀), which adds an offset to average SNR (Eₛ/N₀) and lower triangular matrix L.

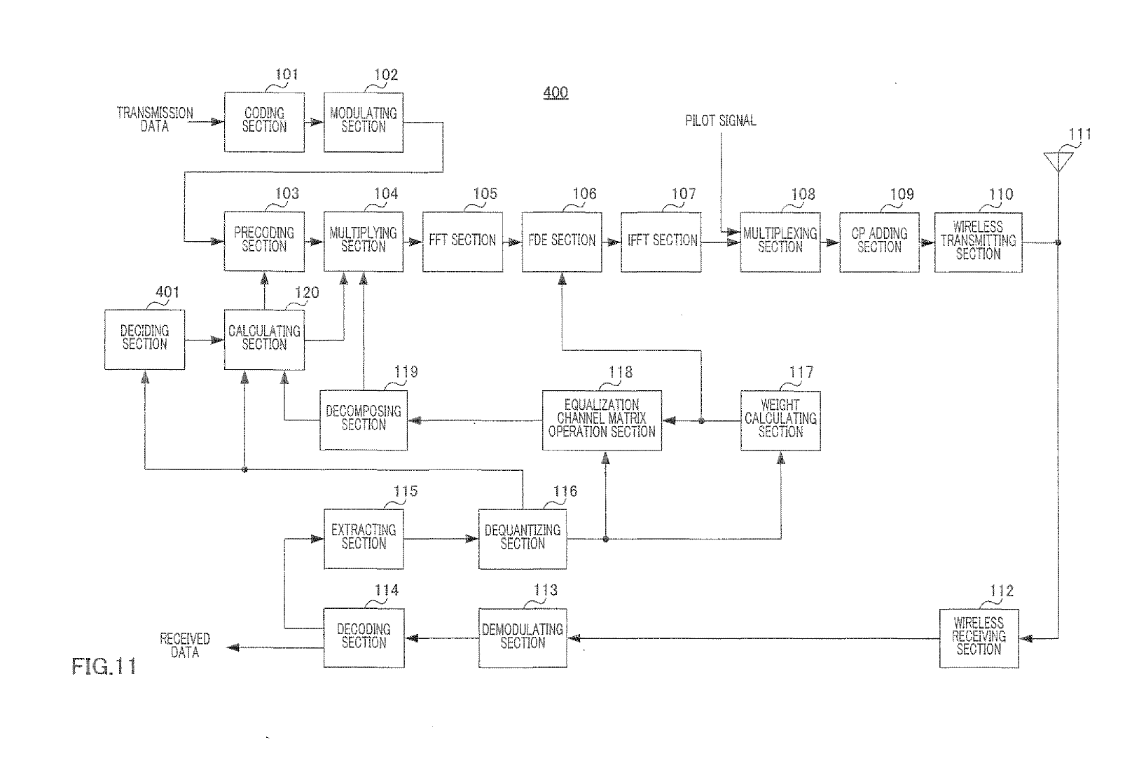

This will be described in detail below. FIG. 11 shows the configuration of radio transmitting apparatus 400 according to the present embodiment. Parts in FIG. 11 that are the same as in FIG. 6 will be assigned the same reference codes as in FIG. 6, and their explanations will be omitted.

Deciding section 401 of radio transmitting apparatus 400 shown in FIG. 11 decides whether or not to add an offset to an average SNR (Eₛ/N₀) based on an average SNR (Eₛ/N₀) received as input from dequantizing section 116. For example, when an average SNR (Eₛ/N₀) received as input from dequantizing section 116 is lower than a predetermined threshold and diagonal elements of matrix B calculated from that average SNR (Eₛ/N₀) fluctuate significantly in a transmission block (for example, when E_{b}/N₀=0 dB as shown in FIG. 10), deciding section 401 decides to add an offset to the average SNR (Eₛ/N₀). Then, deciding section 401 commands calculating section 120 to given an offset to the average SNR (Eₛ/N₀).

Calculating section 120, when commanded by deciding section 401 to give an offset to an average SNR (Eₛ/N₀), gives an offset to an average SNR (Eₛ/N₀) received as input from dequantizing section 116. Then, calculating section 120 calculates matrix B represented by equation 14 using an average SNR (Eₛ/N₀) with an offset, and lower triangular matrix L. That is to say, calculating section 120 calculates matrix B using an average SNR that is different from the actual average SNR, when interference applied against a different radio communication apparatus is significant and the magnitude of interference fluctuates significantly in a transmission block.

To be more specific, first, calculating section 120 sets E_{b}/N₀ offset value Δ_{b}. Then, calculating section 120 calculates matrix B represented by equation 14 using an average SNR (Eₛ/N₀=10 log₁₀(M)+E_{b}/N₀+Δ_{b} [dB]), which adds offset value Δ_{b} to an average SNR (Eₛ/N₀=10 log₁₀(M)+E_{b}/N₀ [dB]).

For example, in the event E_{b}/N₀=0 dB where diagonal elements of matrix B fluctuate significantly in a transmission block, calculating section 120 sets offset value Δ_{b}=5 dB. By this means, calculating section 120 calculates matrix B represented by equation 14 using an average SNR (Eₛ/N₀=10 log₁₀(M)+0+5 [dB]), which adds offset value Δ_{b}=5 dB to an average SNR (Eₛ/N₀=10 log₁₀(M)+0 [dB]). That is to say, when E_{b}/N₀=0 dB, calculating section 120 calculates matrix B of when E_{b}/N₀=5 dB shown in FIG. 10. As shown in FIG. 10, the received quality of diagonal elements of matrix B of when E_{b}/N₀=5 dB is substantially fixed in a transmission block.

Thus, radio transmitting apparatus 400 can suppress the fluctuation of received quality in a transmission block by performing MMSE-THP by giving an offset to an average SNR, even when diagonal elements of matrix B fluctuate significantly in a transmission block, such as when E_{b}/N₀=0 dB, as shown in FIG. 10. By this means, significant fluctuation of interference applied against a different radio communication apparatus is suppressed in a transmission block, so that the different radio communication apparatus is able to perform accurate AMC control. Consequently, it is possible to prevent the system throughput of a mobile communication system from deteriorating.

With the present embodiment, calculating section 120 adds an offset to an average SNR and calculates matrix B using an average SNR that is different from the actual average SNR. That is to say, referring to equation 14, Eₛ/N₀ that is different from the actual value is used, and, consequently, MMSE-THP using calculated matrix B cannot achieve an optimal SNR improvement effect. However, even when calculating section 120 gives an offset to an average SNR, lower triangular matrix L is acquired using the actual CIR, so that the ISI suppression effect does not deteriorate significantly.

Thus, with the present embodiment, diagonal elements of matrix B fluctuate significantly in a transmission block, a radio transmitting apparatus calculates matrix B using an average SNR which adds an offset to an average SNR. By this means, the received quality in a transmission block is smoothed. That is to say, interference given from a different radio communication apparatus does not fluctuate significantly in a transmission block. Consequently, with the present embodiment, even when a plurality of radio communication apparatuses communicate at the same time using the same frequency, each radio communication apparatus is still able to perform accurate AMC control, so that the system throughput of a mobile communication system can be prevented from deteriorating.

With the present embodiment, a case has been described where calculating section 120 gives an offset to an average SNR (Eₛ/N₀) using E_{b}/N₀ offset value Δ_{b}. However, with the present invention, calculating section 120 may given an offset to an average SNR (Eₛ/N₀) or Eₛ/N₀ using average SNR offset value Δ_{SNR} or Eₛ/N₀ offset value Δ_{S}. For example, calculating section 120 may calculate matrix B using average SNR+Δ_{SNR} [dB], which adds average SNR offset value Δ_{SNR} to an average SNR (Eₛ/N₀), and lower triangular matrix L, or may calculate matrix B using Eₛ/N₀+Δ_{S} [dB], which adds Eₛ/N₀ offset value Δₛ to Eₛ/N₀, and lower triangular matrix L. By this means, the same effects as by the present embodiment can be achieved.

Furthermore, with the present embodiment, it is possible to change an MCS set to select in AMC control, based on an offset value. To be more specific, when a radio transmitting apparatus mounted on a radio communication base station apparatus (hereinafter “base station”) performs MMSE-THP transmission with a radio communication apparatus mounted on a given radio communication mobile station apparatus (hereinafter “mobile station”) using matrix B calculated using an average SNR, which adds an offset to an average SNR, the base station may switch to and use for that mobile station an MCS set of lower data transmission speed when the absolute value of the offset value given to that average SNR increases. For example, when the absolute value of an offset value increases, the base station may change an MCS set of a modulation scheme of 16 QAM and a coding rate of ½, to an MCS set of a modulation scheme of QPSK and a coding rate of ⅓, and lower the transmission speed. By this means, it is possible to achieve the same effect as with the present embodiment and also correct the deterioration of received quality due to the use of matrix B calculated using E_{b}/N₀ (or Eₛ/N₀, average SNR, etc.) that is different from the actual channel.

With the present embodiment, the range of offset value fluctuation may be changed on an adaptive basis based on the number of radio communication apparatuses (or the volume of traffic) in a communication system. For example, when the number of radio transmitting apparatuses (for example, radio communication apparatuses having established communication with that radio transmitting apparatus) in a communication system (or the volume of traffic) is decided to be greater than a predetermined threshold, a radio transmitting apparatus mounted on a base station may control the range of offset value fluctuation on an adaptive basis by making the range of offset value fluctuation bigger. Also, when a radio transmitting apparatus is mounted on a mobile station and a base station decides that the number of radio communication apparatuses (for example, radio communication apparatuses having established communication with that base station) in a communication system (or the volume of traffic) is decided to be greater than a predetermined threshold, the base station may control the range of offset value fluctuation on an adaptive basis by commanding the mobile station to make the range of offset value fluctuation smaller. By this means, it is possible to reduce the fluctuation of interference against a different radio communication apparatus in a transmission block when the number of radio communication apparatuses (or the volume of traffic) in a radio communication system is large. Also, when the number of radio communication apparatuses (or the volume of traffic) in a communication system is small, even if a different radio communication apparatus is unable to perform accurate AMC control, this has little impact on the system as a whole. Consequently, by making the range of offset value fluctuation small and using an average SNR that is close to the actual average SNR, it is possible to suppress MMSE-THP performance deterioration in the radio transmitting apparatus, that is, prevent the SNR improvement effect and residual ISI suppression effect of the radio transmitting apparatus from deteriorating. Thus, it is possible to suppress system throughput deterioration by changing the range of offset value fluctuation on an adaptive basis according to the number of radio communication apparatuses (or the volume of traffic) in a communication system.

Furthermore, with the present embodiment, it is equally possible to change the transmission power of an entire transmission block based on an offset value. For example, when a radio transmitting apparatus mounted on a base station apparatus performs MMSE-THP transmission with a radio communication apparatus mounted on a given mobile station using matrix B calculated using an average SNR, which adds an offset to an average SNR (Eₛ/N₀), the base station may increase the transmission power to give to all symbols in a transmission block for that mobile station on an constant basis when the absolute value of an offset value increases. By this means, it is possible to achieve the same effect as with the present embodiment and also correct the deterioration of received quality due to the use of matrix B calculated using E_{b}/N₀ (or Eₛ/N₀, average SNR, etc.) that is different from actual E_{b}/N₀ of the channel.

### Embodiment 3

Referring to equation 14, when an average SNR (Eₛ/N₀) is low, B⁻¹ comes close to (Eₛ/N₀)L^{H} (or B comes close to (Eₛ/N₀)⁻¹L^{-H}), or, when an average SNR (Eₛ/N₀) is high, B⁻¹ comes close to L⁻¹ (or B comes close to L). That is, in MMSE-THP, when an average SNR (Eₛ/N₀) is higher, the significance of an average SNR (Eₛ/N₀) becomes lower, in other words, in MMSE-THP, when an average SNR (Eₛ/N₀) is lower, the significance of average SNR (Eₛ/N₀) becomes higher.

Thus, MMSE-THP according to the present invention operates to provide an ISI suppression effect or an SNR improvement effect depending on an average SNR, the significance of report information to be reported from a radio receiving apparatus also changes depending on an average SNR. That is to say, the significance of CIR information that is necessary to acquire lower triangular matrix L and the significance of SNR information that is necessary to acquire an average SNR (Eₛ/N₀), change depending on an average SNR.

Whatever an average SNR (Eₛ/N₀) is, lower triangular matrix L has significant impact on the calculation of matrix B. The change of significance based on average SNR is greater with an average SNR (Eₛ/N₀) than with lower triangular matrix L.

With the present embodiment, the method of reporting an average SNR (that is, SNR information) from a radio receiving apparatus to a radio transmitting apparatus, is switched according to an average SNR.

Now, average SNR reporting methods 1 and 2 according to the present embodiment will be described.

(Reporting Method 1)

With this reporting method, the period of reporting an average SNR is made longer when an average SNR is higher.

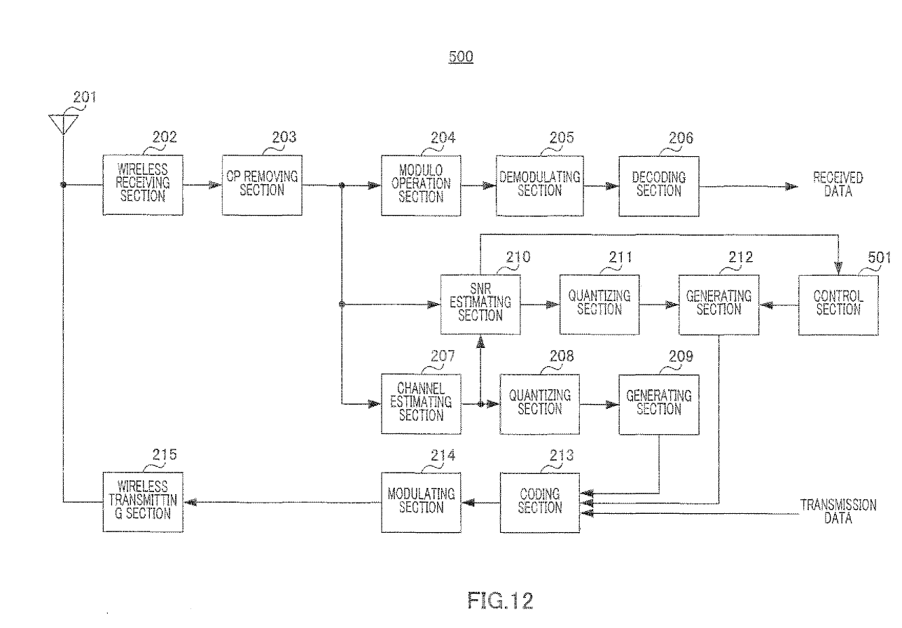

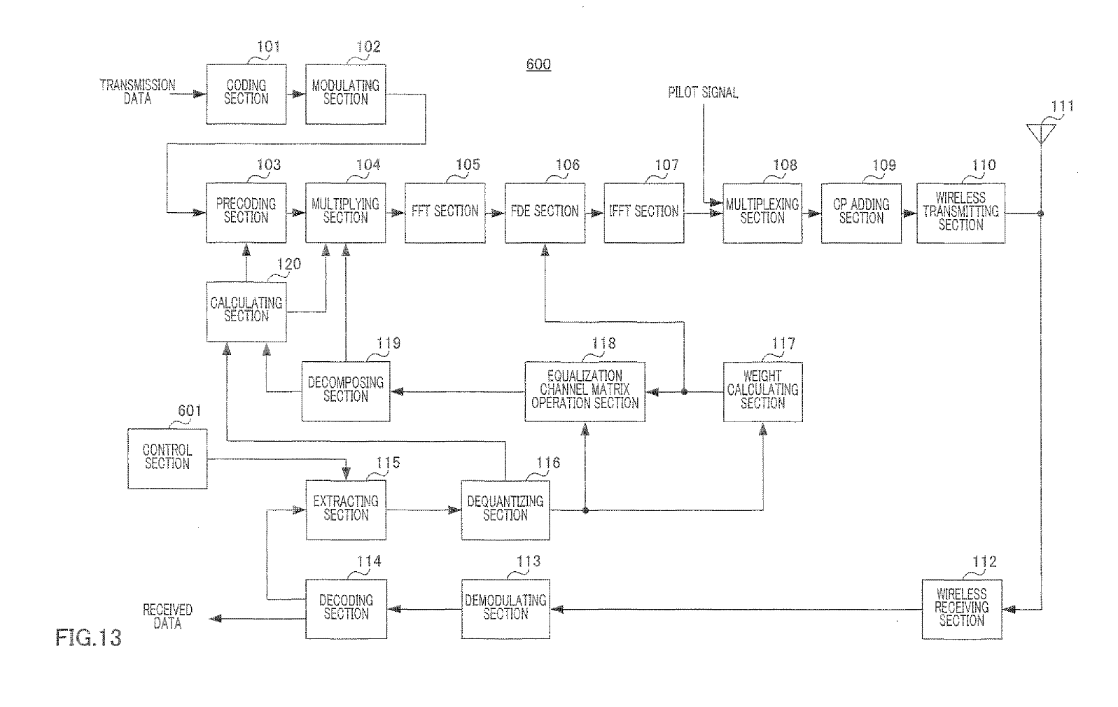

The configurations of a radio transmitting apparatus and a radio receiving apparatus according to the present reporting method will be described. FIG. 12 shows the configuration of radio receiving apparatus 500 according to the present reporting method, and FIG. 13 shows the configuration of radio receiving apparatus 600 according to the present reporting method. Parts in FIG. 12 and FIG. 13 that are the same as in FIG. 6 and FIG. 8 will be assigned the same reference codes as in FIG. 6 and FIG. 8, and their explanations will be omitted.

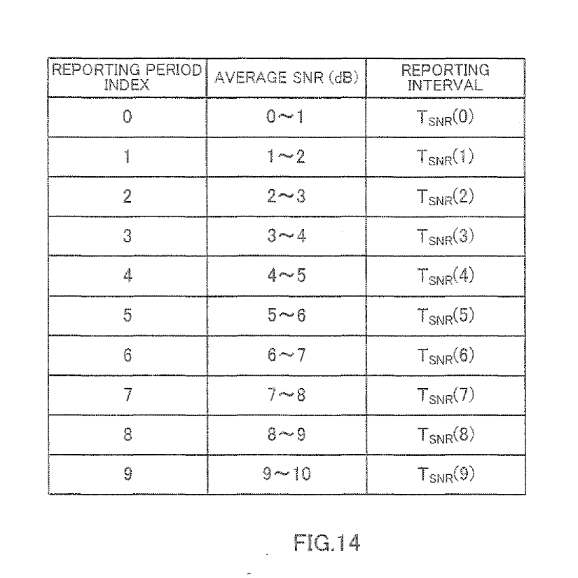

In radio receiving apparatus 500 shown in FIG. 12, control section 501 receives as input an average SNR from SNR estimating section 210. Control section 501 controls the period of reporting an average SNR based on an average SNR. To be more specific, with reference to the table of FIG. 14 showing associations between average SNRs and SNR reporting periods, control section 501 determines the interval of reporting an average SNR. Here, in FIG. 14, reporting interval T_{SNR}(0) is the shortest and reporting interval T_{SNR}(9) is the longest. Also, reporting intervals T_{SNR}(0) to T_{SNR}(9) are set in ascending order from the shortest reporting interval. That is to say, reporting intervals T_{SNR}(0) to T_{SNR}(9) hold the relationship of: reporting interval T_{SNR}(i)≦reporting interval T_{SNR}(i=0˜8). That is to say, according to the associations between average SNRs and average SNR reporting intervals shown in FIG. 14, a longer average SNR reporting interval is used when an average SNR is higher. That is to say, the average SNR reporting period becomes longer when average SNR is higher. Then, control section 501 outputs a determined reporting interval to generating section 212.

Generating section 212 generates SNR information at an interval received as input from control section 501 and outputs SNR information to coding section 213.

Radio transmitting section 215 transmits SNR information showing average SNR to radio transmitting apparatus at in a reporting period determined in control section 501.

Radio receiving section 112 of radio transmitting apparatus 600 shown in FIG. 13 receives SNR information report showing an average SNR, from radio receiving apparatus 500 (FIG. 12). Here, the SNR information reporting period is longer when an average SNR is higher.

Control section 601 holds the same table as the table (FIG. 14) held in control section 501 of radio receiving apparatus 500. Then, control section 601 outputs, for example, the minimum reporting interval T_{SNR}(0) amongst the reporting intervals shown in the table of FIG. 14, to extracting section 115.

Extracting section 115 extracts the SNR information included in a control signal received as input from decoding section 114, at a reporting interval received as input from control section 601. To be more specific, extracting section 115 performs blind detection of control information at minimum reporting interval T_{SNR}(0) and extracts SNR information. By this means, at whatever interval SNR information is reported from radio receiving apparatus 500, extracting section 115 is able to extract SNR information reliably.

By this means, when an average SNR (Eₛ/N₀) is lower (that is to say, when matrix B⁻¹ comes close to (Eₛ/N₀)L^{H}), radio transmitting apparatus 600 receives an average SNR (Eₛ/N₀) in a shorter reporting period. Consequently, radio transmitting apparatus 600 is able improve MMSE-THP performance by calculating matrix B using a newer average SNR (Eₛ/N₀), that is to say, using an average SNR (Eₛ/N₀) that reflects the channel condition at that time.

By contrast with this, an average SNR (Eₛ/N₀) is higher (that is to say, when matrix B⁻¹ comes close to L⁻¹), radio transmitting apparatus 600 receives an average SNR (Eₛ/N₀) in a longer reporting period. Here, when an average SNR (Eₛ/N₀) is higher, an average SNR (Eₛ/N₀) has less impact on the calculation of matrix B. Consequently, radio transmitting apparatus 600 is able to reduce the amount of reporting for reporting an average SNR (that is, the number of bits required to report an average SNR), without causing MMSE-THP performance deterioration.

Thus, with the present reporting method, when an average SNR is higher, the average SNR reporting period is made longer. By this means, a radio transmitting apparatus is able to reduce the amount of control information to be reported from a radio receiving apparatus without causing MMSE-THP performance deterioration.

A case has been described above with the present reporting method where, when an average SNR is higher, the average SNR reporting period is made longer. However, with the present invention, it is equally possible to make the average SNR reporting period longer and make the CIR reporting period shorter when an average SNR is higher. By this means, when a radio transmitting apparatus or a radio receiving apparatus is moving fast, the radio transmitting apparatus is able to acquire CIR, which also fluctuates fast, with high accuracy. By this means, the radio transmitting apparatus is able to perform optimal MMSE-THP without increasing the amount of information to report, in a fast-moving environment.

Also, a case has been described with the present reporting method where radio receiving apparatus 500 transmits SNR information showing an average SNR at a reporting interval determined in control section 501, and where radio transmitting apparatus 600 extracts SNR information showing an average SNR by performing control signal blind detection at the minimum reporting interval amongst a plurality of reporting intervals. However, with the present invention, radio receiving apparatus 500 may report a reporting period index (for example, reporting period indices 0 to 9 shown in FIG. 14) showing a reporting interval determined in control section 501, to radio transmitting apparatus 600 as control information. By this means, control section 601 of radio transmitting apparatus 600 is able to specify a reporting interval based on a reporting period index received. Then, extracting section 115 extracts SNR information showing an average SNR per reporting interval specified by control section 601. By this means, radio transmitting apparatus 600 is able to acquire an average SNR without performing blind detection.

(Reporting Method 2)

With the present reporting method, the amount of SNR reporting information is reduced when an average SNR is higher.

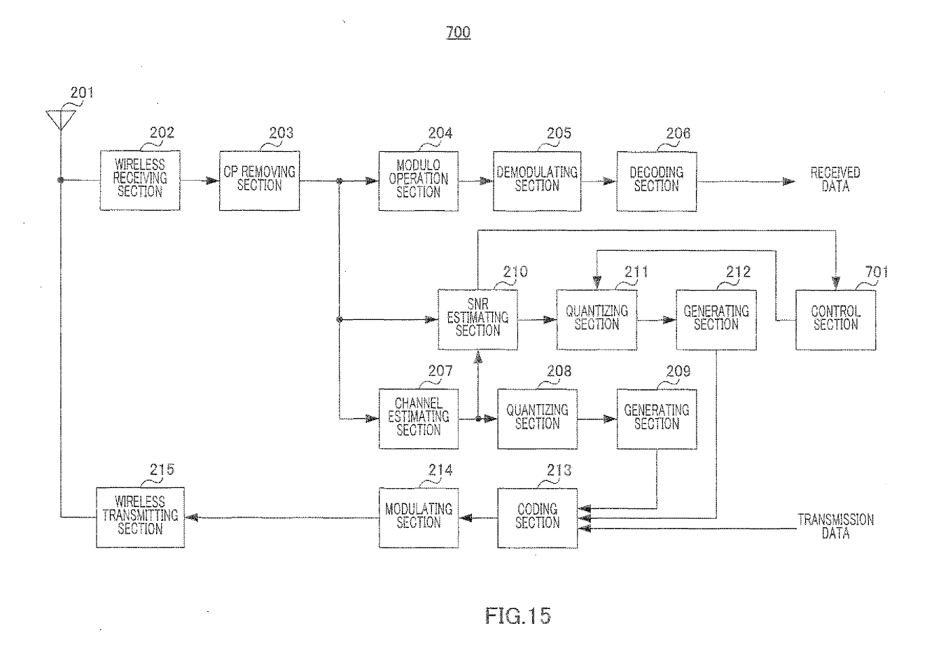

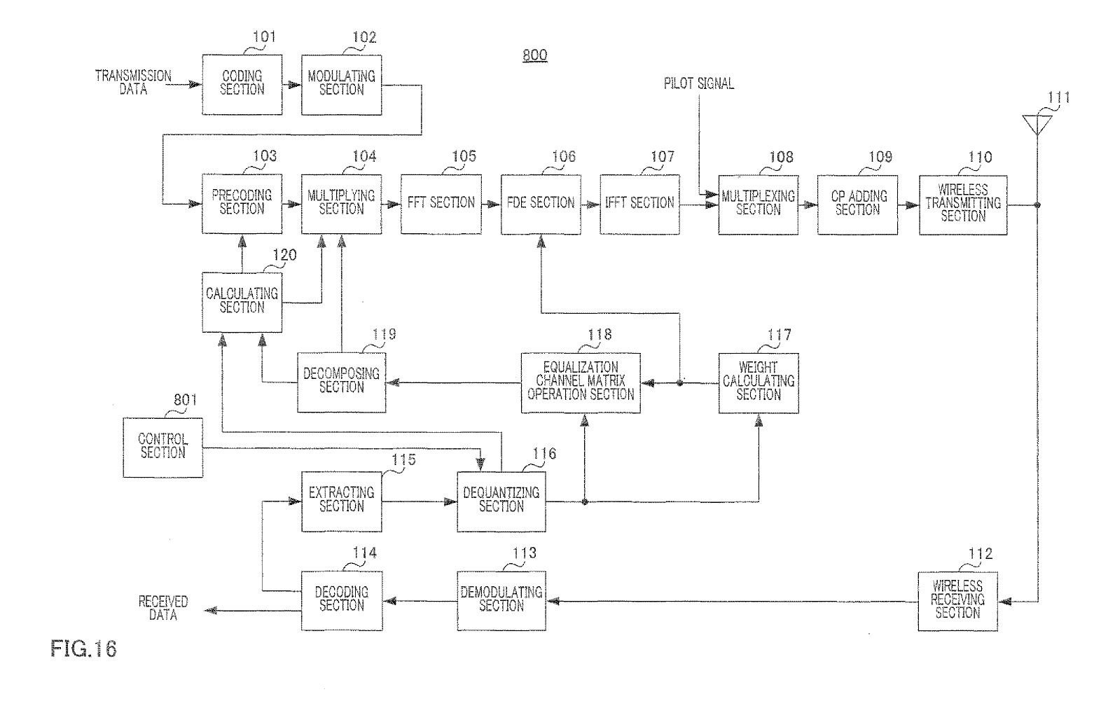

The configurations of a radio transmitting apparatus and radio receiving apparatus according to the present reporting method will be described. FIG. 15 shows a configuration of radio receiving apparatus 700 according to the present reporting method, and FIG. 16 shows a configuration of radio transmitting apparatus 800 according to the present reporting method. Parts in FIG. 15 and FIG. 16 that are the same as in FIG. 6 and FIG. 8 will be assigned the same reference codes as in FIG. 6 and FIG. 8 and their explanations will be omitted.

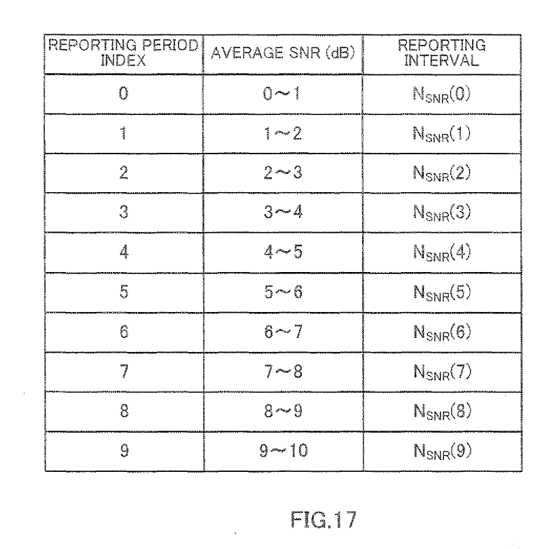

In radio receiving apparatus 700 shown in FIG. 15, control section 701 receives an average SNR as input from SNR estimating section 210. Control section 701 controls the amount of SNR reporting information, that is, the number of bits necessary to report an average SNR, based on an average SNR. To be more specific, control section 701 determines the number of average SNR reporting bits with reference to the table of FIG. 17 showing associations between average SNRs and the numbers of average SNR reporting bits. In FIG. 17, number of reporting bits N_{SNR}(0) is the maximum and number of reporting bits N_{SNR}(9) is the minimum. Furthermore, numbers of reporting bits N_{SNR}(0) to N_{SNR}(9) are set in descending order from the maximum number of reporting bits. That is to say, numbers of bits N_{SNR}(0) to N_{SNR}(9) hold the relationship of: number of reporting bits N_{SNR}(i)≧number of reporting bits N_{SNR}(i+1) (i=0˜8). That is to say, in the associations between average SNRs and the numbers of average SNR reporting bits in FIG. 17, the number of average SNR reporting bits becomes smaller when an average SNR is higher. Then, control section 701 outputs the determined number of reporting bits to quantizing section 211.

Quantizing section 211 quantizes an average SNR received as input from SNR estimating section 210 using the number of reporting bits received as input from control section 701.

Radio transmitting section 215 transmits SNR average information, which shows an average SNR of the number of bits determined in control section 701, to radio transmitting apparatus 800.

Meanwhile, radio receiving section 112 of radio transmitting apparatus 800 shown in FIG. 16 receives SNR information report, which shows an average SNR, from radio receiving apparatus 700 (FIG. 15). The amount of average SNR information represented by SNR information (the number of reporting bits) is smaller when an average SNR is higher.

Control section 801 holds the same table as the table (FIG. 17) held in control section 701. Then, control section 801 outputs all or a predetermined number of numbers of reporting bits, amongst the reporting intervals shown in the table of FIG. 17, to dequantizing section 116.

Dequantizing section 116 dequantizes SNR information using the number of reporting bits received as input from control section 801, and acquires an average SNR. To be more specific, dequantizing section 116 dequantizes SNR information using different numbers of reporting bits until SNR information is accurately dequantizes.

By this means, when an average SNR (Eₛ/N₀) is lower (that is to say, when matrix B comes close to (Eₛ/N₀)L^{H}), radio transmitting apparatus 800 receives an average SNR (Eₛ/N₀) quantized by a greater number of reporting bits. By this means, radio transmitting apparatus 800 can improve MMSE-THP performance by calculating matrix B using a more accurate average SNR (Eₛ/N₀).

By contrast with this, when an average SNR (Eₛ/N₀) is higher (that is to say, when matrix B⁻¹ comes close to L⁻¹), radio transmitting apparatus 800 receives an average SNR (Eₛ/N₀) quantized by a smaller number of reporting bits. Similar to reporting method 1, when an average SNR (Eₛ/N₀) is higher, an average SNR (Eₛ/N₀) has less impact on the calculation of matrix B. Consequently, radio transmitting apparatus 800 is able to reduce the amount of reporting for reporting an average SNR (that is, the number of bits required to report an average SNR), without causing MMSE-THP performance deterioration.

Thus, according to the present reporting method, when an average SNR is higher, the amount of SNR reporting information is made smaller. By this means, similar to reporting method 1, a radio transmitting apparatus is able to reduce the amount of control information to report from a radio receiving apparatus without causing MMSE-THP performance deterioration.

A case has been described with the present reporting method where the number of average SNR reporting bits is made smaller when an average SNR is higher. However, with the present invention, it is equally possible to make the number of average SNR reporting bits smaller and also make the number of CIR reporting bits bigger when an average SNR is higher. By this means, when an average SNR (Eₛ/N₀) is higher (that is to say, when matrix B⁻¹ comes close to L⁻¹), a radio transmitting apparatus is able to acquire CIR, which is more significant information than an average SNR (Eₛ/N₀), with high accuracy. Consequently, a radio transmitting apparatus is able to improve MMSE-THP performance without increasing the amount of information to report.

Furthermore, a case has been described above with the present reporting method where radio receiving apparatus 700 quantizes an average SNR by the number of reporting bits determined in control section 701, and radio transmitting apparatus 800 dequantizes SNR information using a plurality of numbers of reporting bits in order from a given number of reporting bits. However, with the present invention, radio receiving apparatus 700 may report a number-of-reporting-bits index (for example, number-of-reporting-bits indices 0 to 9 shown in FIG. 17) showing the number of reporting bits determined in control section 701, to radio transmitting apparatus 600 as control information. By this means; control section 801 of radio transmitting apparatus 800 is able to specify the number of reporting bits based on the number-of-reporting-bits index received. Then, dequantizing section 116 dequantizes SNR information using the number of reporting bits specified in control section 801. By this means, radio transmitting apparatus 800 is able to acquire an average SNR without dequantizing a plurality of numbers of reporting bits in order.

Average SNR reporting methods 1 and 2 according to the present embodiment have been described above.

With the present embodiment, thus, by changing the method of reporting an average SNR according to an average SNR, it is possible to achieve the same effect as by embodiment 1 and furthermore reduce the amount of control signal information to report from a radio receiving apparatus to a radio transmitting apparatus.

Although a case has been described above with the present embodiment where the method of reporting an average SNR is changed based on an average SNR, it is equally possible to change the method of reporting CIR based on an average SNR. As explained earlier, when an average SNR is lower, MMSE-THP operates to achieve an SNR improvement effect more than an ISI suppression effect. That is to say, when an average SNR (Eₛ/N₀) is lower, lower triangular matrix L is less significant than lower triangular matrix L is when an average SNR (Eₛ/N₀) is higher. Then, for example, it is possible to make the CIR reporting period longer when an average SNR is lower. It is also possible to make the number of CIR reporting bits smaller when an average SNR is lower. By this means, it is possible to reduce the amount of CIR reporting information without causing MMSE-THP performance deterioration.

Although a case has been described above with the present embodiment where transmission PDE and MMSE-THP are used in combination, is equally possible to adopt above reporting methods 1 and 2 when transmission signal processing is performed based on an MMSE criterion (that is, when, for example, transmission equalization is performed based on an MMSE criterion). By this means, it is possible to reduce the amount of control signal information to report from a radio receiving apparatus to a radio transmitting apparatus without causing performance deterioration of transmission signal processing based on an MMSE criterion.

Embodiments of the present invention have been described above.

The radio transmitting apparatus and radio receiving apparatus of the present invention are suitable for use in, for example, a radio communication mobile station apparatus and radio communication base station apparatus to use in a mobile communication system. It is possible to provide a radio communication mobile station apparatus and a radio communication base station apparatus of the same operations and effects as described above, by mounting a radio transmitting apparatus and a radio receiving apparatus of the present invention on a radio communication mobile station apparatus and a radio communication base station apparatus.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSITs, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-234979, filed on Sep. 12, 2008, including the specification, drawings and abstract, is incorporated herein by reference in its entirety.

### INDUSTRIAL APPLICABILITY

The present invention is applicable to a communication system.

1. A radio transmission apparatus comprising:
an operating section that calculates an equalization channel matrix representing an equalization channel formed with a weight to use in an equalization processing of a transmission block and a channel impulse response;
a decomposing section that acquires a lower triangular matrix L and a unitary matrix Q by performing an LQ decomposition of the calculated equalization channel matrix, the lower triangular matrix L composing of elements representing interference of the transmission block and diagonal elements representing channel quality of the transmission block including higher channel quality in front of the transmission block and lower channel quality in the rear of the transmission block;
a calculating section that calculates a matrix B that minimizes a total of mean square errors of all symbols, between the transmission block prior to a precoding and a received block in a radio reception apparatus, using the acquired lower triangular matrix L and average channel quality;
a precoding section that performs a Tomlinson-Harashima precoding of the transmission block using the calculated matrix B; and
an equalization section that performs an equalization processing of the transmission block using the weight.

2. The radio transmission apparatus according to claim 1,
wherein:
the calculating section calculates the matrix B represented by equation 1 using the lower triangular matrix L and the average channel quality:
$$\begin{matrix}( Equation 1 ) & \\ B = {L}^{- H} [ {L}^{H} L + {( \frac{{E}_{s}}{{N}_{0}} )}^{- 1} I ] & [ 1 ]\end{matrix}$$
where I is a unit matrix, Eₛ/Nₒ is a signal energy to noise power spectrum density ratio per symbol, representing the average channel quality, and superscript H is a Hermitian transpose.

3. The radio transmission apparatus according to claim 1, further comprising a multiplying section that multiplies the transmission block after the precoding by power equalization coefficient Ω calculated according to equation 2 using diagonal element b_{τ,τ} of the matrix B,
$$\begin{matrix}( Equation 2 ) & \\ Ω = \sqrt{{N}_{c} / {\sum }_{τ = 0}^{{N}_{c} - 1} ( 1 / {\vert {b}_{τ , τ} \vert}^{2} )} & [ 2 ]\end{matrix}$$
wherein τ ranging from 0 to N_{C}−1, N_{C} being a block length of the transmission block, and
the equalization section performs equalization processing of the multiplexed transmission block:

4. The radio transmission apparatus according to claim 1, wherein the calculating section calculates the matrix B using the lower triangular matrix L and other average channel quality which adds an offset to the average channel quality.

5. The radio transmission apparatus according to claim 1, further comprising a reception section that receives information on the average channel quality from the radio reception apparatus, wherein a reporting period of the information on the average channel quality is longer when the average channel quality is higher.

6. The radio transmission apparatus according to claim 1, further comprising a reception section that receives information on the average channel quality from the radio reception apparatus, wherein an amount of the information on the average channel quality is less when the average channel quality is higher.

7. A precoding method comprising:
calculating an equalization channel matrix representing an equalization channel formed with a weight to use in an equalization processing of a transmission block and a channel impulse response;
acquiring a lower triangular matrix L and a unitary matrix Q by performing an LQ decomposition of the calculated equalization channel matrix, the lower triangular matrix L composing of elements representing interference of the transmission block and diagonal elements representing channel quality of the transmission block including higher channel quality in front of the transmission block and lower channel quality in the rear of the transmission block;
calculating a matrix B that minimizes a total of mean square errors of all symbols, between the transmission block prior to a precoding and a received block in a radio reception apparatus, using the acquired lower triangular matrix L and average channel quality; and
performing a Tomlinson-Harashima precoding of the transmission block using the calculated matrix B.
